(19) United States
(12) Patent Application Publication
(10) Pub. No.: US 2022/0038346 A1
(43) Pub. Date: Feb. 3, 2022

(54) TRANSMISSION DEVICE AND TRANSMISSION METHOD

(71) Applicant: FUJITSU LIMITED, Kawasaki-shi (JP)

(72) Inventor: Yuji TOCHIO, Yokohama (JP)

(73) Assignee: FUJITSU LIMITED, Kawasaki-shi (JP)

(21) Appl. No.: 17/329,508

(22) Filed: May 25, 2021

(30) Foreign Application Priority Data
Jul. 29, 2020 (JP) 2020-128250

(51) Int. Cl. H04L 12/24; H04L 12/42

(52) U.S. Cl. CPC H04L 41/0896; H04L 2012/421; H04L 12/42; H04L 41/0893

(57) ABSTRACT

A transmission device includes a processor configured to arrange a traffic in one or more slots assigned, based on slot information, in an overhead among slots of a frame signal received in one of a first transmitter/receiver and a second transmitter/receiver and to be transmitted from the other, acquire traffic information that indicates an increase or decrease in the traffic, and update the slot information so that a number of slots in which the traffic is accommodated increases or decreases, based on the traffic information, generate a message regarding update of the slot information based on the increase or decrease in the traffic, and insert the message into the overhead of the frame signal received in the one of the first transmitter/receiver and the second transmitter/receiver and to be transmitted from the other.

### CROSS-REFERENCE TO RELATED APPLICATION

This application is based upon and claims the benefit of the prior Japanese Patent Application No. 2020-128250, filed on Jul. 29, 2020, the entire contents of which are incorporated herein by reference.

### FIELD

The embodiments discussed herein are related to a transmission device and a transmission method.

### BACKGROUND

With the distribution of data centers, the “Flex Ethernet” technology defined by the Optical Internetworking group Forum (OIF) has been considered to be applied as one of technologies for transmitting large-capacity Ethernet (registered trademark, the same applies hereinafter) signals between data centers. According to the “Flex Ethernet” technology, client signals with transfer rates (e.g., 10 Gbps, 40 Gbps, 25 Gbps, etc.) that are not defined as data rates for international standard Ethernet may be accommodated by multiplexing the client signals into a frame signal of 100 Gigabit Ethernet (GbE) (registered trademark, the same applies hereinafter).

In connection with the “Flex Ethernet” technology, for example, Patent Document 1 discloses that client signals received by nodes in a ring network are code-multiplexed (byte-multiplexed) and transmitted between nodes.

Further, as a low-latency and large-capacity network technology applicable to the 5th Generation (5G) network, there is an Ethernet Virtual Private Network (EVPN) that implements a VPN of a layer 2. The EVPN is defined by the Request For Comments (RFC) 7432 and RFC 8365 issued by the Internet Engineering Task Force (IETF).

The EVPN technology is an extension of Border Gateway Protocol (BGP) and may provide multipoint services with higher performance than regular VPNs. The EVPN is also said to contribute to the majority connections and ultra-low latency communications used for 5G networks by supporting a “Dual Homing” function (see, e.g., RFC 7433), a “MAC Mobility” function (see, e.g., RFC 7432), and the majority connections (see, e.g., RFC 8365). Related techniques are disclosed in, for example, Japanese Laid-Open Patent Publication No. 2020-014182.

### SUMMARY

According to an aspect of the embodiments, a transmission device provided at a node of a plurality of nodes that forms a ring network, the transmission device includes a port configured to receive traffic in which an accommodation destination node of the plurality of nodes switches between the nodes, a first transmitter/receiver configured to transmit/receive a frame signal that includes a plurality of slots and an overhead to/from one node of adjacent nodes of the plurality of nodes, a second transmitter/receiver configured to transmit/receive the frame signal to/from an other node of the adjacent nodes, and a processor configured to arrange the traffic in one or more slots assigned, based on slot information, in the overhead among the slots of the frame signal received in one of the first transmitter/receiver and the second transmitter/receiver and to be transmitted from an other of the first transmitter/receiver and the second transmitter/receiver, the slot information indicating one or more slots allocated to the frame signal, acquire traffic information that indicates an increase or decrease in the traffic, update the slot information so that a number of slots in which the traffic is accommodated increases or decreases, based on the traffic information, generate a message regarding update of the slot information based on the increase or decrease in the traffic, and insert the message into the overhead of the frame signal received in the one of the first transmitter/receiver and the second transmitter/receiver and to be transmitted from the other of the first transmitter/receiver and the second transmitter/receiver.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of two ring networks connected to each other;

FIG. 2 is a diagram illustrating an example of a code multiplex transmission in a ring network;

FIG. 3 is a diagram illustrating an example of a frame signal;

FIG. 4 is a diagram illustrating an example of a slot allocation process of an Ethernet signal;

FIG. 5 is a diagram illustrating an example of a collection message and a setting message;

FIG. 6 is a diagram illustrating an example of transmitting an Ethernet signal from an end user's terminal to a node's transmission device via an access device;

FIG. 7 is a diagram illustrating the bandwidth of a ring network NW before movement of a terminal;

FIG. 8 is a diagram illustrating the bandwidth of the ring network NW after movement of the terminal;

FIG. 9 is a sequence diagram illustrating an example of a slot information update process by a message exchange;

FIG. 10 is a diagram illustrating an example of an instruction message and a response message;

FIG. 11 is a configuration diagram illustrating an example of an access device;

FIG. 12 is a flowchart illustrating an example of a control signal transmission process of an access device;

FIG. 13 is a configuration diagram illustrating an example of a transmission device;

FIG. 14 is a configuration diagram illustrating an example of a control unit;

FIG. 15 is a flowchart illustrating an example of processing of an instruction message and a response message;

FIG. 16 is a configuration diagram illustrating an example of another access device;

FIG. 17 is a flowchart illustrating an example of a control signal transmission process of another access device;

FIG. 18 is a configuration diagram illustrating an example of another control unit;

FIG. 19 is a diagram illustrating the bandwidth of a ring network before movement of a terminal when slots are allocated to a free bandwidth;

FIG. 20 is a diagram illustrating the bandwidth of the ring network NW after movement of the terminal when slots are allocated to a free bandwidth;

FIG. 21 is a configuration diagram illustrating an example of yet another access device;

FIG. 22 is a flowchart illustrating an example of a control signal transmission process of yet another access device;

FIG. 23 is a configuration diagram illustrating an example of yet another control unit;

FIG. 24 is a diagram illustrating the bandwidth of a ring network before movement of a terminal when slots are allocated to fixed traffic;

FIG. 25 is a diagram illustrating the bandwidth of the ring network after movement of the terminal when slots are allocated to fixed traffic;

FIG. 26 is a configuration diagram illustrating an example of yet another access device; and

FIG. 27 is a flowchart illustrating an example of a control signal transmission process of yet another access device.

### DESCRIPTION OF EMBODIMENTS

The EVPN technology may be applied to a ring network capable of large-capacity transmission as disclosed in Japanese Laid-Open Patent Publication No. 2020-014182 to establish a network corresponding to a moving end user, such as, for example, an automobile network. In the ring network, when a node, which is an accommodation destination of traffic from the end user, switches to another node by EVPN signaling as the end user moves, it may be considered to preset and secure the traffic bandwidth for each node. However, in this case, as the number of end users with traffic accommodated in the nodes in the ring network increases, the bandwidth in the ring network may be compressed, resulting in a bandwidth shortage. Since the ring network has fewer switchable traffic paths than a mesh network, it is difficult to efficiently secure the bandwidth as the end user moves. Hereinafter, embodiments of the technology capable of efficiently securing the bandwidth in a ring network according to the movement of an end user will be described in detail based on the drawings. The disclosed technology is not limited by the embodiments. In addition, the embodiments illustrated below may be used in proper combination unless contradictory.

### Embodiments

### [Ring Network]

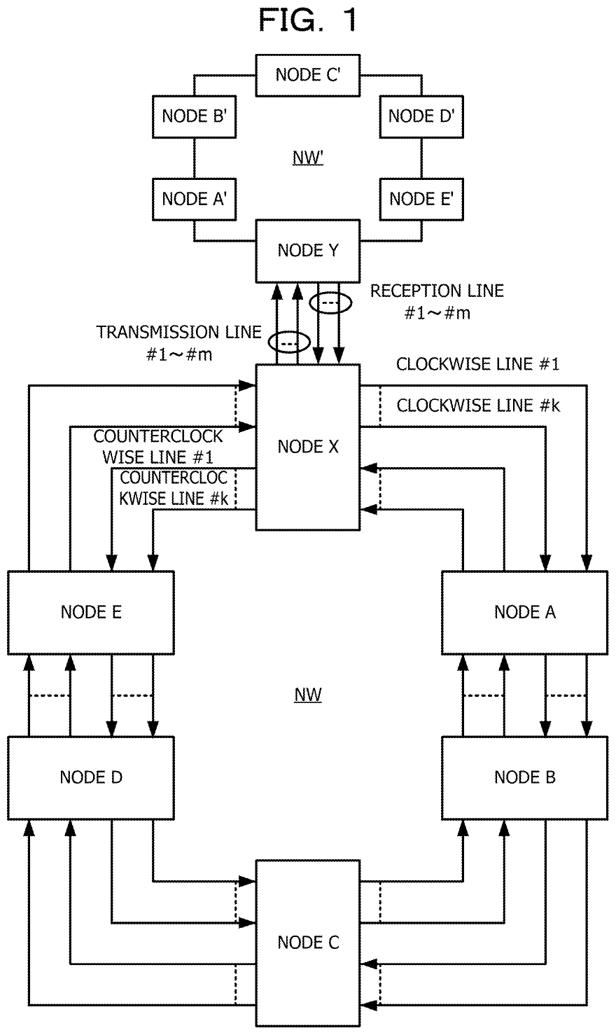

FIG. 1 is a configuration diagram illustrating an example of two ring networks NW and NW′ connected to each other. As illustrated, a node X, which is a parent node, and nodes A to E, which are child nodes, are connected to one ring network NW, and the nodes A to E and X are adjacent to each other. The node Y, which is a parent node, and nodes A′ to E′, which are child nodes, are connected to another ring network NW′, and the nodes A′ to E′ and Y are adjacent to each other.

The ring networks NW and NW′ are connected to each other at the nodes X and Y. In the following description, the operation of one ring network NW will be described, but the operation of another ring network NW′ is substantially the same.

The node X communicates with the node Y via transmission lines #1 to #m and reception lines #1 to #m (where m is a positive integer). The node X transmits a frame signal to the node Y via the transmission lines #1 to #m and receives a frame signal from the node Y via the reception lines #1 to #m according to the “Flex Ethernet” technology of the OIF. The transmission lines #1 to #m and the reception lines #1 to #m are accommodated in individual transmission paths.

The nodes A to E and X transmit/receive frame signals to/from their adjacent nodes A to E and X via clockwise lines #1 to #k and counterclockwise lines #1 to #k. For example, the node D receives a frame signal from the adjacent node C via the clockwise lines #1 to #k and transmits the frame signal to the adjacent node E. Further, the node D receives a frame signal from the adjacent node E via the counterclockwise lines #1 to #k and transmits the frame signal to the adjacent node C.

The frame signal transmitted from the node X to the node Y accommodates a data signal transmitted from at least a part of the nodes A to E. The frame signal accommodating the data signal is transmitted from each of the nodes A to E to the node X via the clockwise line #1 to #k and the counterclockwise lines #1 to #k. The node X accommodates the data signal from each of the nodes A to E in one frame signal and transmits the data signal to the node Y. As a result, the data signals from the nodes A to E are transmitted to the nodes A′ to E′.

Further, the node X receives a frame signal accommodating a data signal from the nodes A′ to E′, from the node Y via the reception lines #1 to #m. The node X separates the data signal from the frame signal received from the node Y and accommodates the data signal in a frame signal of the clockwise lines #1 to #k or the counterclockwise lines #1 to #k according to the reception destination nodes A to E. Each of the nodes A to E separates the reception target data signal from the frame signal of the clockwise lines #1 to #k or the counterclockwise line #1 to #k. As a result, the data signal from the nodes A′ to E′ is transmitted to the nodes A to E.

An example of transmitting a data signal from the nodes A to E to the node Y is given below.

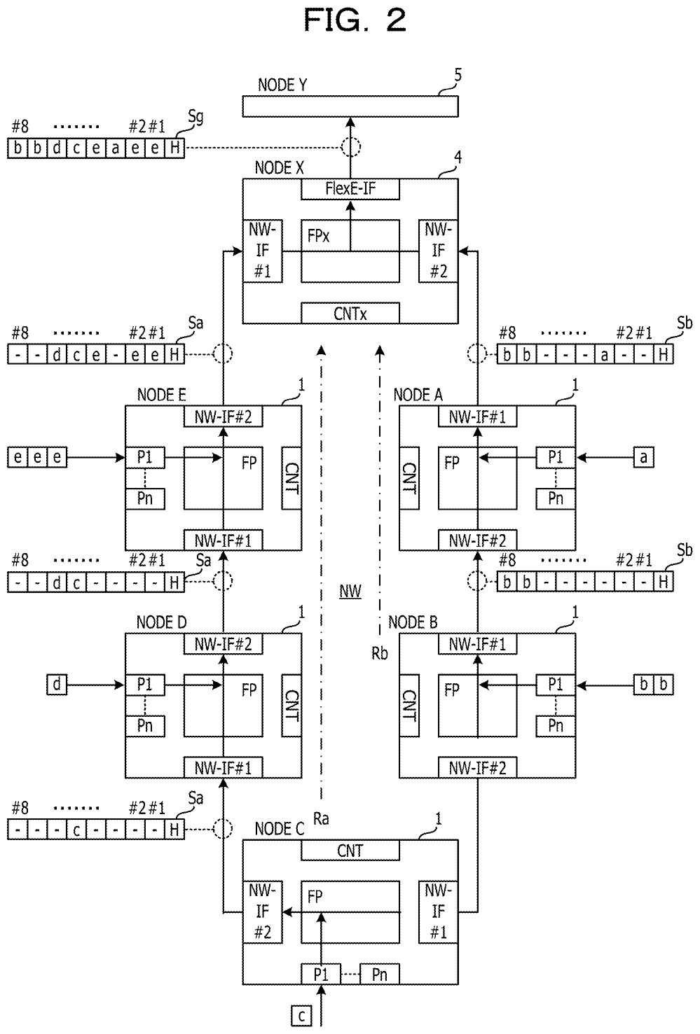

FIG. 2 is a diagram illustrating an example of code multiplex transmission in the ring network NW. In FIG. 2, arrows indicate how frame signals Sa, Sb, and Sg are transmitted from each of the nodes A to E to the node Y through the node X. Further, the frame signals Sa, Sb, and Sg drawn by dotted lines from the arrows connecting the nodes A to E, X, and Y are transmitted in the sections of the arrows.

Each of the nodes A to E is provided with a transmission device 1 that performs a code multiplex transmission (byte multiplex transmission). The transmission device 1 is a device that executes a transmission method of the embodiment. The nodes X and Y are provided with transmission devices 4 and 5, respectively, which perform a code multiplex transmission. The code multiplex transmission is performed between the transmission devices 4 and 5 according to the “Flex Ethernet” technology of the OIF.

The transmission devices 1 of the nodes A to E are each provided with a transmission control unit CNT, network interface units NW-IF #1 and #2, a frame processing unit FP, and ports P1 to Pn (where n is a positive integer). The transmission device 4 of the node X is provided with a transmission control unit CNTx, a frame processing unit FPx, network interface units NW-IF #1 and #2, and a Flex Ethernet interface unit FlexE-IF.

In the transmission device 1 of each of the nodes A to E, the ports P1 to Pn transmit and receive an Ethernet signal based on the “Flex Ethernet” technology. The ports P1 to Pn include a transmitting port for transmitting the Ethernet signal to a data center DC and a receiving port for receiving an Ethernet signal from the data center DC. In this example, it is assumed that at least the port P1 is the receiving port.

Ethernet signals “a” to “e” are transmitted as client signals from each data center DC to the port P1. The number of ports P1 to Pn in each transmission device 1 is not limited. Further, the case where the Ethernet signals “a” to “e” are input only to the ports P1 is described in this example, but the present disclosure is not limited thereto, and the Ethernet signals “a” to “e” may be input to the other ports P2 to Pn.

The network interface units NW-IF #1 and #2 transmit and receive the frame signals Sa and Sb between adjacent nodes A to E and X on both sides in the ring network NW. One of the network interface units NW-IF #1 and #2 of each of the nodes A to E is an example of a first transmission/reception unit, and the other is an example of a second transmission/reception unit.

The frame processing unit FP accommodates the Ethernet signals “a” to “e” in the frame signals Sa and Sb transmitted from one of the network interface units NW-IF #1 and #2. Further, the frame processing unit FPx separates the Ethernet signals “a” to “e” from the frame signals Sa and Sb received by the network interface units NW-IF #1 and #2 and accommodates the separated Ethernet signals in one frame signal Sg. The frame signal Sg in which the Ethernet signals “a” to “e” are accommodated is transmitted from the Flex Ethernet interface unit FlexE-IF to the node Y. Further, the transmission control units CNT and CNTx control the transmission process of the frame signals Sa, Sb and Sg.

Each of the frame signals Sa, Sb, and Sg includes an overhead H functioning as a control channel, and slots #1 to #8 in which the Ethernet signals “a” to “e” are accommodated. The slots #1 to #8 are illustrated as a part of all the slots of the frame signals Sa, Sb, and Sg.

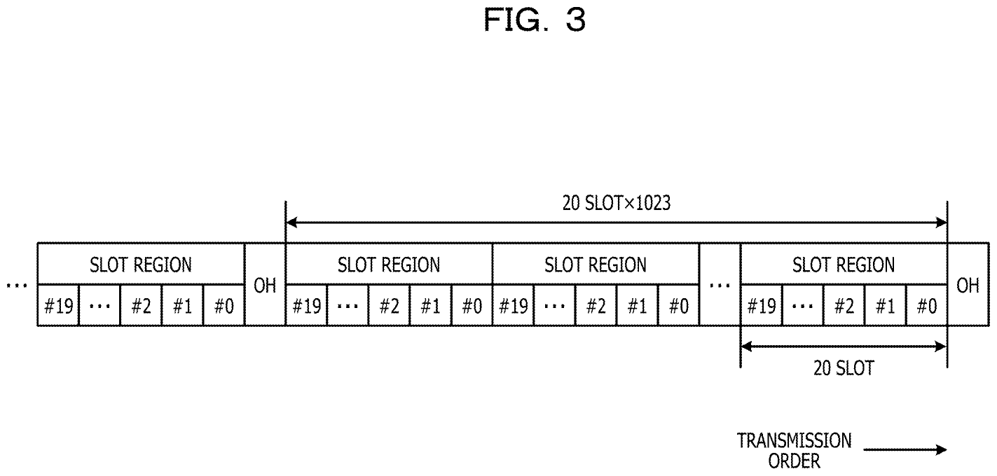

FIG. 3 is a diagram illustrating an example of the frame signals Sa, Sb, and Sg. Each of the frame signals Sa, Sb, and Sg includes slot regions, each of which has, for example, 20 slots (#0, #1, . . . , #19), and an overhead OH (the above-mentioned H) inserted every 1023 slot regions. The overhead OH contains various control messages. The frame signals Sa, Sb, and Sg are sequentially transmitted in the right direction of the paper in FIG. 2 (see “transmission order”).

The Ethernet signals “a” to “e” equivalent to, for example, 5 Gbps are accommodated in each slot. Therefore, one multiplexed frame is capable of accommodating a client signal of 100(=5×20) Gbps. The data format in each slot may be, for example, 66B block, but is not limited thereto.

As the paths of the frame signals Sa and Sb reaching the node X, there are a path Ra from the node C to the node X through the node D and the node E, and a path Rb from the node B to the node X through the node A. The frame signal Sa is transmitted along the path Ra by any of the clockwise lines #1 to #k, and the frame signal Sb is transmitted along the path Rb by any of the counterclockwise lines #1 to #k.

In the transmission device 1 of the node B, the Ethernet signal “b” of 10 Gbps is input to the port P1. In FIG. 2, one square indicating the Ethernet signals “a” to “e” represents a bandwidth of 5 Gbps. Therefore, two squares of the Ethernet signal “b” represent 10 Gbps.

The frame processing unit FP of the node B accommodates the Ethernet signal “b” in the slots #7 and #8 of the frame signal Sb transmitted from the network interface unit NW-IF #1. The frame signal Sb transmitted from the network interface unit NW-IF #1 of the node B is received by the network interface unit NW-IF #2 of the node A. In the transmission device 1 of the node A, the Ethernet signal “a” of 5 Gbps is input to the port P1. The frame processing unit FP of the node A accommodates the Ethernet signal “a” in the slot #3 of the frame signal Sb received by the network interface unit NW-IF #2 and transmitted from the network interface unit NW-IF #1. The frame signal Sb transmitted from the network interface unit NW-IF #1 of the node A is received by the network interface unit NW-IF #2 of the node X.

In this way, the Ethernet signals “a” and “b” of the nodes A and B are accommodated in the frame signal Sb of the path Rb. Meanwhile, the Ethernet signals “c,” “d,” and “e” of the nodes C to E are multiplexed on the frame signal Sa of the path Ra by the same operation as the above nodes A and B. The frame signal Sa transmitted from the network interface unit NW-IF #2 of the node E is received by the network interface unit NW-IF #1 of the node X.

The “-” (hyphen) in the frame signals Sa, Sb, and Sg means an empty slot in which the Ethernet signals “a” to “e” are not accommodated, and corresponds to the “unavailable” slot of the “Flex Ethernet” technology. The positions of the empty slots of the frame signals Sa and Sb input to the node X from the paths Ra and Rb have a staggered relationship.

More specifically, the empty slots of the frame signal Sb of the path Rb are the slots #1, #2, and #4 to #6, but the Ethernet signals “e,” “c,” and “d” are accommodated in the slots #1, #2, and #4 to #6 of the frame signal Sa of the path Ra. Meanwhile, the empty slots of the frame signal Sa of the path Ra are the slots #3, #7, and #8, but the Ethernet signals “a” and “b” are accommodated in the slots #3, #7, and #8 of the frame signal Sb of the path Rb.

The transmission device 4 of the node X synthesizes the frame signals Sa and Sb input from the paths Ra and Rb into one frame signal Sg and transmits the frame signal Sg from the Flex Ethernet interface unit FlexE-IF to the transmission device 5 of the node Y. At this time, the frame processing unit FPx separates the Ethernet signals “e,” “c,” and “d” from the frame signal Sa of the path Ra, separates the Ethernet signals “a” and “b” from the frame signal Sb of the path Rb, and accommodates the Ethernet signals “a” to “e” in the same slot of the common frame signal Sg.

As a result, the two frame signals Sa and Sb received from different paths are synthesized into one frame signal Sg. The frame processing unit FPx outputs the synthesized frame signal Sg to the Flex Ethernet interface unit FlexE-IF.

In this way, the frame processing unit FPx of the node X generates the frame signal Sg in which the Ethernet signals “a” to “e” are accommodated, from the frame signals Sa and Sb received by the network interface units NW-IF #1 and #2, respectively.

More specifically, the frame processing unit FPx acquires the Ethernet signals “e,” “c,” and “d” from the slots #1, #2, and #4 to #6 of the frame signal Sa and accommodates the acquired Ethernet signals in the slots #1, #2, and #4 to #6 of the frame signal Sg. Further, the frame processing unit FPx acquires the Ethernet signals a and b from the slots #3, #7, and #8 of the frame signal Sb and accommodates the acquired Ethernet signals in the slots #3, #7, and #8 of the frame signal Sg.

Therefore, even when the transmission device 4 of the node X receives the frame signals Sg from different paths Ra and Rb in the ring network NW, the frame signals Sg may be synthesized into one frame signal Sg which may be then transmitted to the node Y.

In order to perform the code multiplex transmission as described above, each of the transmission devices 1 and 4 allocates the slots #1 to #8 to each of the Ethernet signals “a” to “e” according to a process to be described below.

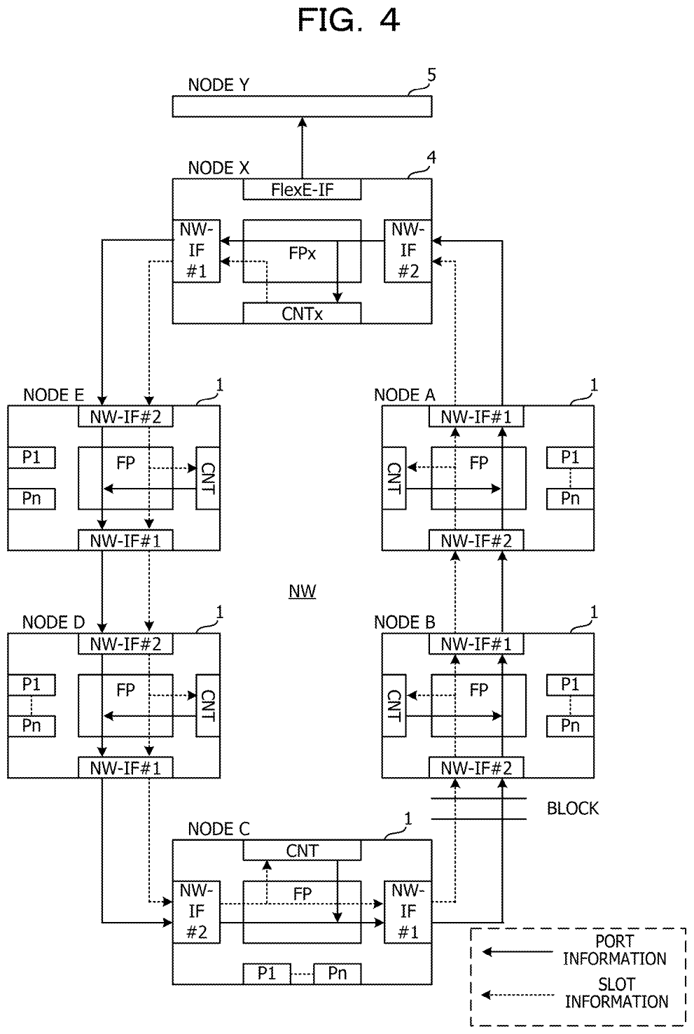

FIG. 4 is a diagram illustrating an example of a slot allocation process of the Ethernet signals “a” to “e.” In FIG. 4, the configurations common to FIG. 2 are denoted by the same symbols, and the explanation thereof will not be repeated.

The slot allocation process of the Ethernet signals “a” to “e” includes, first, a step of collecting port information of each of the nodes A to E, and a step of setting slot information from the node X to each of the nodes A to E. In FIG. 4, a solid arrow exemplifies the transmission direction of the port information, and a dotted arrow exemplifies the transmission direction of the slot information.

The port information indicates allocation of the Ethernet signals “a” to “e” to the ports P1 to Pn in each of the nodes A to E. The transmission control unit CNT of each of the nodes A to E assigns the port information to the overhead H (OH) of the frame signal transmitted from the network interface unit NW-IF #1. The frame signal including the port information is transmitted on any of the clockwise lines #1 to #k and the counterclockwise lines #1 to #k.

In each of the nodes A to E, the frame signal including the port information is transmitted from the network interface unit NW-IF #1 to the adjacent nodes A to E and X on one side. Therefore, the port information is sequentially assigned to the common overhead H in each of the nodes A to E. As a result, the port information of each of the nodes A to E is collected in one frame signal. The port information may be generated in advance by the transmission control unit CNT, or may be set in each transmission device 1 from a network management device (OpS or the like) (not illustrated).

The frame signal accommodating the port information is generated by the transmission control unit CNT of the node B, which is, as an example, a master node, and is received in the node X via the ring network NW in the order of nodes A, X, E, D, C, B, and A. A node that generates the frame signal accommodating the port information is not limited to the node B, but may be the node X.

The transmission control unit CNTx of the node X acquires the port information of all the child nodes A to E from the frame signal received by the network interface unit NW-IF #2 and generates the slot information of each of the nodes A to E based on the acquired port information. The slot information indicates the allocation of the Ethernet signals “a” to “e” for each of the port P1 to Pn to the slots of the frame signals Sa, Sb, and Sg based on the port information.

The transmission control unit CNTx assigns the slot information to the overhead H of the frame signal transmitted from the network interface unit NW-IF #1. The frame signal accommodating the slot information is transmitted from the network interface unit NW-IF #1 to the adjacent node E on one side. The frame signal is transmitted through the ring network NW in the order of nodes E, D, C, B, and A and returns to the node X where the frame signal is discarded.

In the transmission device 1 of each of the nodes A to E, the transmission control unit CNT acquires the slot information from the overhead H of the frame signal received by the network interface unit NW-IF #2 and allocates the slots to the Ethernet signals “a” to “e” based on the slot information. The frame processing unit FP accommodates the Ethernet signals “a” to “e” in the slots of the frame signals Sa and Sb according to the allocation. As a result, the transmission process illustrated in FIG. 3 is performed. The transmission control unit CNT is an example of a control unit.

The port information is included in a collection message accommodated in the overhead H. Further, the slot information is included in a setting message accommodated in the overhead H.

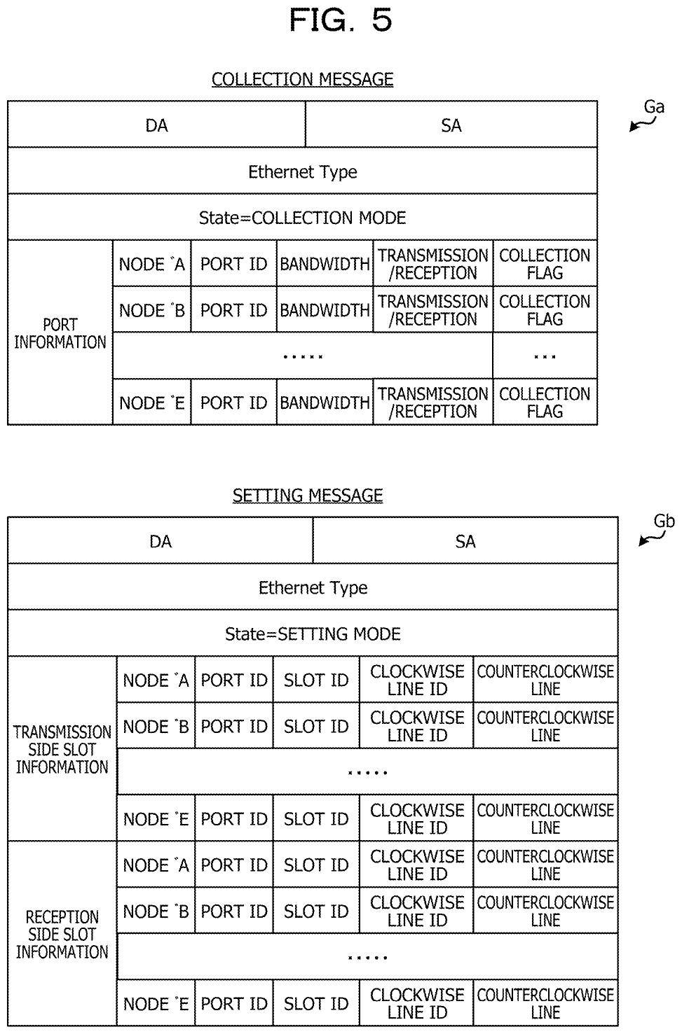

FIG. 5 is a diagram illustrating an example of the collection message (see, e.g., symbol Ga) and the setting message (see, e.g., symbol Gb). Each of the collection message and the setting message includes a destination address (DA) indicating a reception destination, a transmission source address (SA) indicating a transmission source, a fixed value “Ethernet Type”, and a “State” indicating an operating state. The transmission devices 1 and 4 identify the message type by “State.”

The “State” of the collection message indicates a collection mode, and the port information of each of the node A to E is included in the collection message. The transmission control units CNT of the nodes A to E assign the port information of its own nodes A to E to the collection message. The port information includes identifiers of the nodes A to E, port IDs which are identifier of the ports P1 to Pn, bandwidths of the Ethernet signals “a” to “e,” and information for distinguishing between a transmitting port and a receiving port (hereinafter, referred to as “transmission/reception” information).

As described above, the port information indicates the allocation of the Ethernet signals “a” to “e” to the ports P1 to Pn. Since the port information includes the allocation of the bandwidth of the Ethernet signals “a” to “e” to the ports P1 to Pn, the transmission control unit CNTx of the node X may allocate the number of slots corresponding to the bandwidth to the Ethernet signals “a” to “e.” The bandwidth for each of the ports P1 to Pn may not be included in the port information, and may be set in the transmission control unit CNTx from, for example, a network management device.

In addition, a collection flag is assigned to the collection message for each of the nodes A to E. The collection flag indicates whether the nodes A to E have assigned the port information. The collection flag indicates the completion (“1”) or incompletion (“0”) of the assignment of the port information for each of the nodes A to E.

The transmission control unit CNTx of the node X may determine from the collection flag whether the collection of the port information of each of the nodes A to E has been completed. The transmission control unit CNTx generates the slot information when the collection of the port information has been completed. The slot information includes transmitting side slot information indicating the allocation of each slot of the frame signal Sg transmitted from the node X to the node Y, and receiving side slot information indicating the allocation of each slot of the frame signal accommodating the Ethernet signals included in the frame signal received from the node Y. The transmitting side slot information indicates the allocation of slots to the Ethernet signals “a” to “e” received by the receiving port of each of the nodes A to E, and the receiving side slot information indicates the allocation of slots to the Ethernet signals transmitted from the transmitting port of each of the nodes A to E.

When generating the transmitting side slot information, the transmission control unit CNTx specifies a receiving port of each of the nodes A to E according to the “transmission/reception” information of the port information. The transmission control unit CNTx allocates slots to the receiving port of each of the nodes A to E according to the bandwidth indicated by the port information. Therefore, as in the example of FIG. 3, three slots are allocated to the Ethernet signal “e” of 15 Gbps, and one slot is allocated to the Ethernet signal “d” of 5 Gbps. Therefore, the transmission device 1 of each of the nodes A to E may secure the number of slots according to the bandwidth of the Ethernet signals “a” to “e.” The transmission control unit CNT generates the transmitting side slot information based on the allocation result.

When generating the receiving side slot information, the transmission control unit CNTx specifies a transmitting port of each of the nodes A to E according to the “transmission/reception” information of the port information. The transmission control unit CNTx acquires a calendar from, for example, the overhead of the frame signal received from the node Y, and generates the reception slot information based on the calendar and the port information. The transmission control unit CNT generates a setting message including the transmitting side slot information and the receiving side slot information and assigns the setting message to the overhead H.

The “State” of the setting message indicates a setting mode, and the setting message includes the transmitting side slot information and the receiving side slot information of each of the nodes A to E. Each of the transmitting side slot information and the receiving side slot information includes identifiers of the nodes A to E, port IDs which are identifiers of the ports P1 to Pn, and slot IDs. The slot IDs indicate the slot numbers #1 to #20, which are positions in the frame signal of the slot.

Further, each of the transmitting side slot information and the receiving side slot includes a clockwise line ID for identifying the clockwise lines #1 to #k and a counterclockwise line ID for identifying the counterclockwise lines #1 to #k. The transmission control unit CNTx selects unused lines from the clockwise lines #1 to #k and the counterclockwise lines #1 to #k, respectively, and allocates the selected unused lines to the Ethernet signals transmitted and received by each of the nodes A to E.

Based on the corresponding transmitting side slot information, the transmission control unit CNT of each of the nodes A to E allocates slots of the transmission target frame signals Sa and Sb of the lines #1 to #k indicated by the clockwise line ID and the counterclockwise line ID to the Ethernet signals received at the receiving port. The frame processing unit FP accommodates the Ethernet signals “a” to “e” in the empty slots of the frame signals Sa and Sb transmitted to the adjacent nodes A to E and X according to the allocation.

In this way, the frame processing unit FP accommodates the Ethernet signals “a” to “e” in slots allocated based on the transmitting side slot information among the slots of the frame signals Sa and Sb received from one of the network interface units NW-IF #1 and #2 and transmitted from the other.

Further, based on the corresponding receiving slot information, the transmission control unit CNT of each of the nodes A to E allocates the Ethernet signals transmitted from the transmitting port, to slot of the reception target frame signal of the lines #1 to #k indicated by the clockwise line ID and the counterclockwise line ID. The frame processing unit FP separates the Ethernet signals from the slots of the reception target frame signal among the slots of the frame signal received from the adjacent nodes A to E and X according to the allocation.

### [Example of Accommodating Traffic of Moving Terminal]

The EVPN technology may be applied to the ring network NW to establish a network corresponding to a moving end user, such as, for example, an automobile network. Each of the transmission devices 1 of the nodes A to E transmits/receives an Ethernet signal to/from an end user's terminal via an access device.

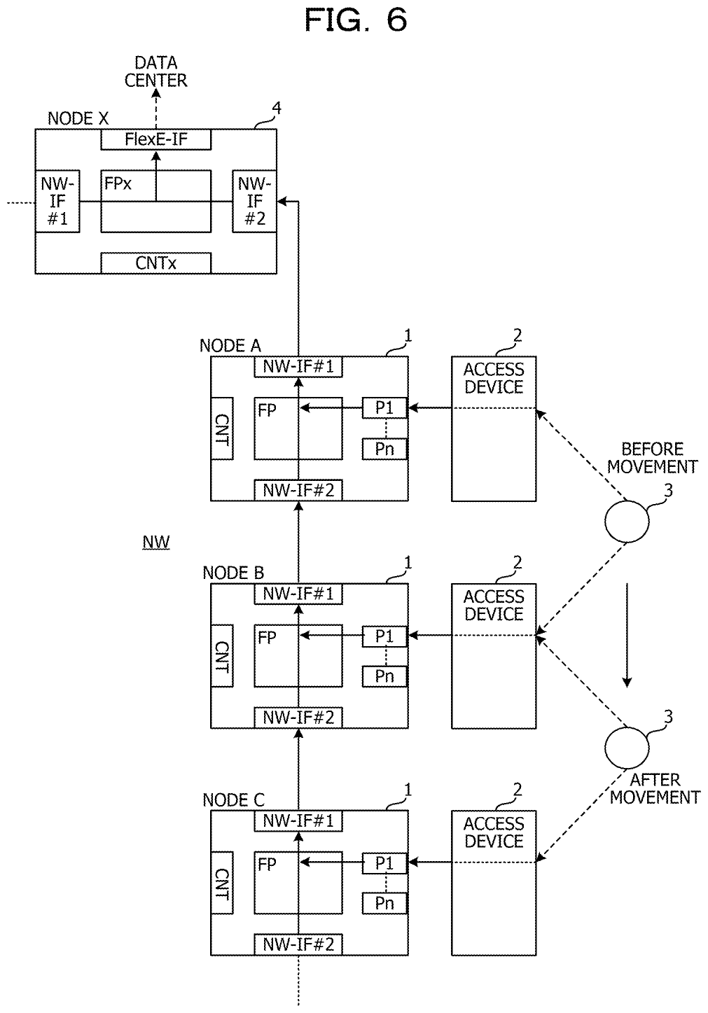

FIG. 6 is a diagram illustrating an example in which an Ethernet signal is transmitted from an end user's terminal 3 to the transmission devices 1 of the nodes A to C via an access device 2. In FIG. 6, the configurations common to FIG. 2 are denoted by the same symbols, and the explanation thereof will not be repeated.

The access device 2 is connected to the transmission device 1 of each of the nodes A to C. Although not illustrated, the access device 2 is also connected to the transmission devices 1 of the other nodes D and E. The access device 2 accommodates an access line (see, e.g., a dotted line) of the end user's terminal 3. The access line is an example of a communication line that transmits traffic. An example of the end user's terminal 3 may include an Internet On Things (IoT) device mounted on a moving object such as an automobile. Since the terminal 3 moves with the movement of the end user, the accommodation destination access device 2 of the access line switches.

For example, the access line of the terminal 3 is accommodated in two access devices 2 by the “Dual Homing” function of the EVPN technology. In the terminal 3, the accommodation destination access device 2 of the access line switches according to the movement of the end user. As an example, the access line of the terminal 3 before the movement is accommodated in each of the access devices 2 of the nodes A and B, and the access line of the terminal 3 after the movement is accommodated in each of the access devices 2 of the nodes B and C.

The access device 2 receives the Ethernet signal from the terminal 3, multiplexes the received Ethernet signal with an Ethernet signal from another terminal, and transmits the multiplexed Ethernet signal to the port P1 of the transmission device 1. Here, the access device 2 may multiplex Ethernet signals into one frame signal according to the “Flex Ethernet” technology, as in the transmission device 1.

In this way, in the traffic from the terminal 3, the accommodation destination node switches from the nodes A and B to the nodes B and C as the end user moves. An example of controlling the bandwidth of the ring network NW in this case will be described below.

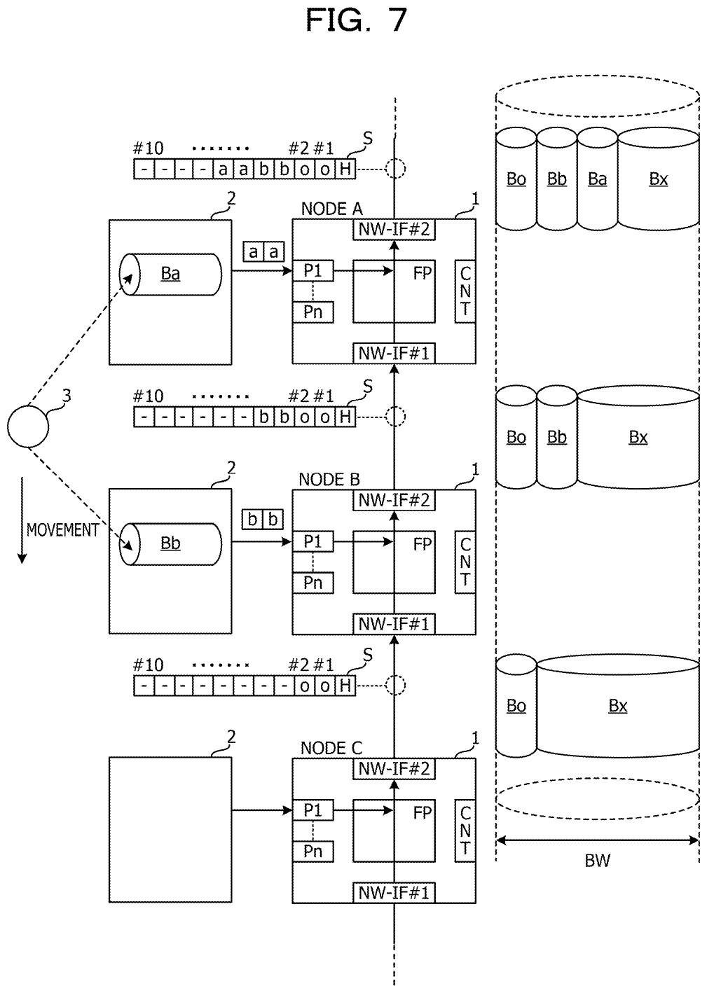

FIG. 7 is a diagram illustrating the bandwidth BW of the ring network NW before the movement of the terminal 3. The access line of the terminal 3 is accommodated in the access devices 2 of the nodes A and B. The traffic of the Ethernet signal transmitted from the terminal 3 is divided and transmitted to the access device 2 connected to each of the transmission devices 1 of the nodes A and B.

The transmission device 1 of the node A receives the Ethernet signal “a” of the bandwidth Ba from the access device 2. The transmission device 1 of the node B receives the Ethernet signal “b” of the bandwidth Bb from the access device 2.

As an example, a frame signal S including the slots #1 to #10 is transmitted to the ring network NW in the direction from the transmission device 1 of the node C toward the transmission device 1 of the node A. The network interface unit NW-IF #2 of the transmission device 1 of the node C transmits the frame signal S in which the Ethernet signal “o” is accommodated in the slots #1 and #2, to the transmission device 1 of the adjacent node B.

The bandwidth BW of a predetermined counterclockwise line between the transmission devices 1 of the nodes C and B includes the bandwidth Bo of the Ethernet signal “o,” and an unused bandwidth Bx. The bandwidth of the overhead H is ignored.

The port P1 of the transmission device 1 of the node B receives the Ethernet signal “b” from the access device 2. The transmission control unit CNT allocates the slots #3 and #4 to the Ethernet signal “b” based on the slot information. The frame processing unit FP accommodates the Ethernet signal “b” in the slots #3 and #4 of the frame signal S received from the node C. The network interface unit NW-IF #2 transmits the frame signal S to the transmission device 1 of the adjacent node A.

The bandwidth BW of a predetermined counterclockwise line between the transmission devices 1 of the nodes A and B includes the bandwidth Bo of the Ethernet signal “o,” the bandwidth Bb of the Ethernet signal “b,” and an unused bandwidth Bx.

The port P1 of the transmission device 1 of the node A receives the Ethernet signal “a” from the access device 2. The transmission control unit CNT allocates the slots #5 and #6 to the Ethernet signal “b” based on the slot information. The frame processing unit FP accommodates the Ethernet signal “a” in the slots #5 and #6 of the frame signal S received from the node B. The network interface unit NW-IF #2 transmits the frame signal S to the transmission device 1 of the adjacent node X.

The bandwidth BW of a predetermined counterclockwise line between the transmission devices 1 and 4 of the nodes A and X includes the bandwidth Bo of the Ethernet signal “o,” the bandwidth Bb of the Ethernet signal “b,” the bandwidth Ba of the Ethernet signal “a,” and an unused bandwidth Bx.

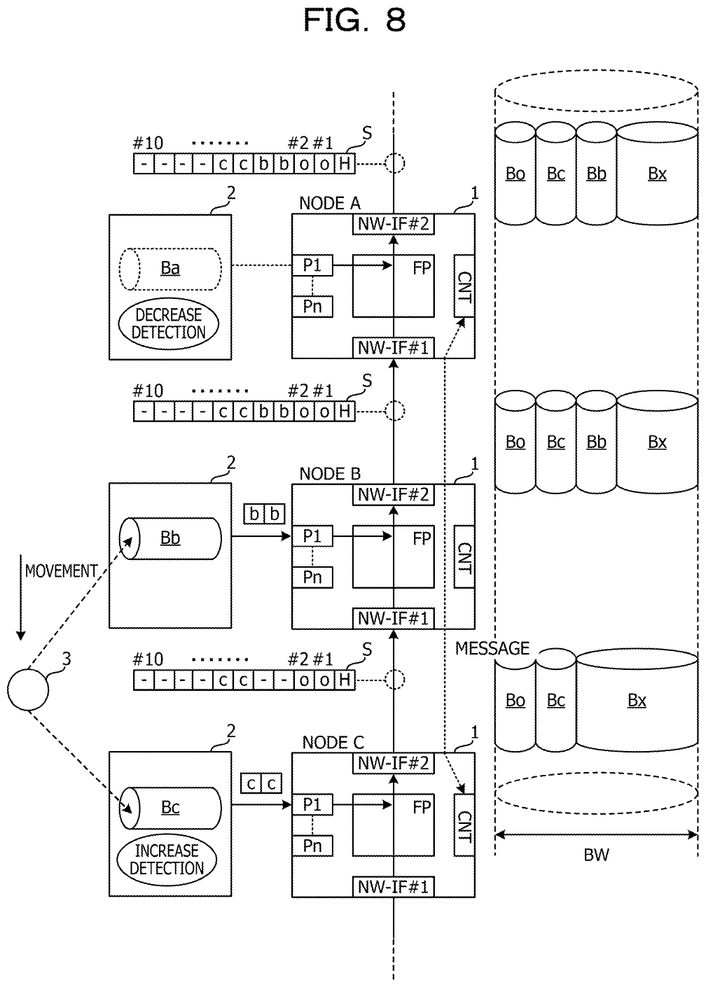

FIG. 8 is a diagram illustrating the bandwidth BW of the ring network NW after the movement of the terminal 3. The access line of the terminal 3 is accommodated in the access devices 2 of the nodes B and C. The traffic of the Ethernet signal transmitted from the terminal 3 is divided and transmitted to the access device 2 connected to each of the transmission devices 1 of the nodes B and C.

The access device 2 connected to the transmission device 1 of the node C detects a decrease in traffic from the terminal 3 as the terminal 3 moves, and notifies the decrease in traffic to the transmission device 1 of the node C. Further, the access device 2 connected to the transmission device 1 of the node A detects an increase in traffic from the terminal 3 as the terminal 3 moves, and notifies the increase in traffic to the transmission device 1 of the node A.

When receiving the notification from the access device 2, the transmission control unit CNT of each of the transmission devices 1 of the nodes A and C generates and exchanges a message regarding update of the slot information due to the increase or decrease of traffic from the terminal 3. The transmission control unit CNT of each of the transmission devices 1 of the nodes A and C inserts the message into the overhead H of the frame signal S and the overhead H of another frame signal transmitted in the direction opposite to the frame signal S.

The transmission control unit CNT of the transmission device 1 of the node A updates the slot information so that the allocation of the slots #5 and #6 for the Ethernet signal “a” is deleted as a result of message exchange. As the result of message exchange, the transmission control unit CNT of the transmission device 1 of the node C updates the slot information so that the slots #5 and #6 are allocated to the Ethernet signal “c.” Further, the transmission control unit CNT of the transmission device 1 of the node B updates the slot information by relaying the message between the transmission devices 1 of the nodes A and C.

The port P1 of the transmission device 1 of the node C receives the Ethernet signal “c” from the access device 2. The transmission control unit CNT allocates the slots #5 and #6 allocated to the Ethernet signal “a” by the transmission device 1 of the node A, to the Ethernet signal “c” based on the updated slot information. The frame processing unit FP accommodates the Ethernet signal “c” in the slots #5 and #6 of the frame signal S received from the node D. The network interface unit NW-IF #2 transmits the frame signal S to the transmission device 1 of the adjacent node B.

The bandwidth BW of a predetermined counterclockwise line between the transmission devices 1 of the nodes A and B includes the bandwidth Bo of the Ethernet signal “o,” the bandwidth Bc of the Ethernet signal “c,” and an unused bandwidth Bx.

The transmission device 1 of the node B accommodates the Ethernet signal “b” in the slots #3 and #4 of the frame signal S and transmits the Ethernet signal “b” to the transmission device 1 of the adjacent node A, as before the movement of the terminal 3. The bandwidth BW of a predetermined counterclockwise line between the transmission devices 1 of the nodes B and A includes the bandwidth Bo of the Ethernet signal “o,” the bandwidth Bc of the Ethernet signal “c,” the bandwidth Bb of the Ethernet signal “b,” and an unused bandwidth Bx.

The transmission device 1 of the node A transmits the frame signal S to the node X based on the updated slot information without accommodating the Ethernet signal “a” in the frame signal S. The bandwidth BW of a predetermined counterclockwise line between the transmission devices 1 and 4 of the nodes A and X includes the bandwidth Bo of the Ethernet signal “o,” the bandwidth Bc of the Ethernet signal “c,” the bandwidth Bb of the Ethernet signal “b,” and an unused bandwidth Bx.

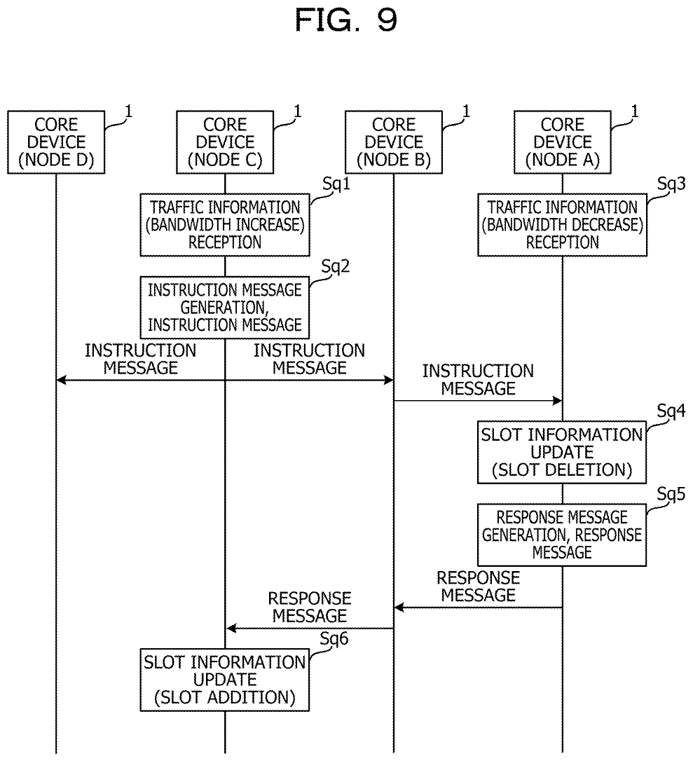

FIG. 9 is a sequence diagram illustrating an example of a slot information update process by a message exchange. The transmission device 1 of the node C receives traffic information indicating an increase in the traffic of the terminal 3 as the end user moves, from the access device 2 (see the symbol Sq1).

Next, the transmission device 1 of the node C generates an instruction message instructing the update of the slot information (see the symbol Sq2), and transmits the instruction message to the transmission devices 1 of the adjacent nodes B and D on both sides. At this time, the transmission control unit CNT inserts the instruction message into the overhead H of each of the frame signals S of the clockwise line and the counterclockwise line. The instruction message inserted into the frame signal of the clockwise line is transmitted to the transmission device 1 of the node A via the transmission device 1 of the node B.

The transmission device 1 of the node A receives traffic information indicating a decrease in traffic of the terminal 3 as the end user moves, from the access device 2 (see, e.g., the symbol Sq3). After receiving the traffic information, the transmission control unit CNT of the transmission device 1 of the node A receives the instruction message. The transmission control unit CNT of the transmission device 1 of the node A updates the slot information so that the slots allocated to the traffic of the terminal 3 is deleted, according to the instruction message.

Next, the transmission control unit CNT of the transmission device 1 of the node A generates a response message to the instruction message. The transmission device 1 of the node A inserts the response message into the overhead H of the frame signal of the clockwise line toward the node C, which is the transmission source of the instruction message. The instruction message is transmitted to the transmission device 1 of the node C via the transmission device 1 of the node B.

After transmitting the instruction message, the transmission control unit CNT of the transmission device 1 of the node C receives the response message from the transmission device 1 of the node A. The transmission control unit CNT of the transmission device 1 of the node C updates the slot information so that the slots are allocated to the traffic of the terminal 3, in response to the reception of the response message.

The instruction message inserted into the frame signal of the counterclockwise line is transmitted to the transmission device 1 of the node D, but is discarded without receiving by any of the transmission devices 1 of the nodes D and E up to the transmission device 4 of the node X.

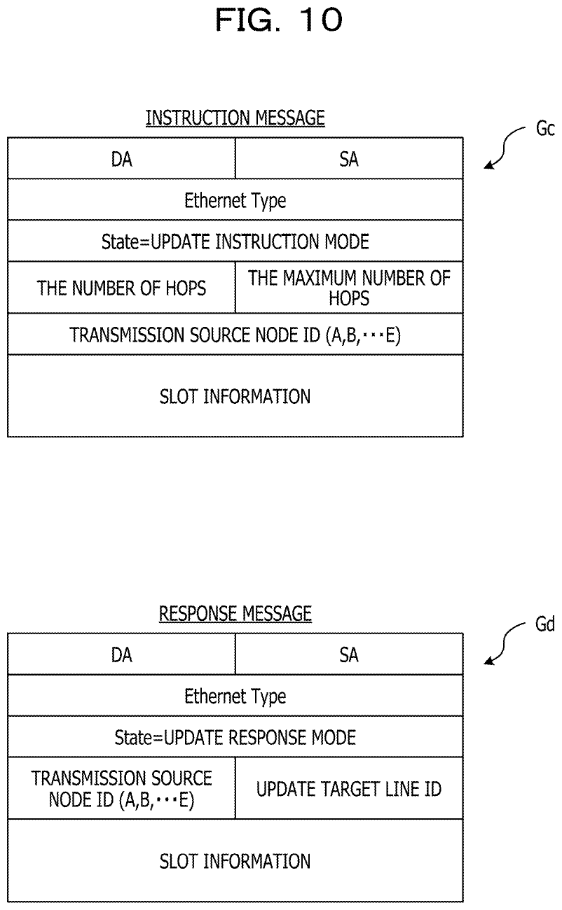

FIG. 10 is a diagram illustrating an example of the instruction message (see the symbol Gc) and the response message (see, e.g., the symbol Gd). Each of the instruction message and the response message includes DA, SA, “Ethernet Type”, and “State.” The “State” of the instruction message indicates an update instruction mode, and the “State” of the response message indicates an update response mode. As described above, the transmission control unit CNT identifies the type of message by the “State.”

The instruction message further includes the number of hops, the maximum number of hops, a transmission source node ID, an update target line ID, and slot information. The number of hops indicates the number of number of times the instruction message has been transferred between nodes. The transmission control unit CNT adds 1 to the number of hops each time it receives the instruction message. The maximum number of hops indicates the maximum number of number of times the instruction message may be transferred. When the number of hops exceeds the maximum number of hops, the transmission control unit CNT discards the instruction message. As a result, the instruction message is suppressed from going around the nodes A to E and X in the ring network NW.

The transmission source node ID is an identifier of a node (the node C in this example) that is the transmission source of the instruction message. The transmission control unit CNT selects a line of a frame signal accommodating the response message from the clockwise line and the counterclockwise line according to the transmission source node ID included in the instruction message. The update target line ID is an identifier (#1 to #k) of the clockwise line or the counterclockwise line of the update target of the slot information.

The response message further includes a transmission source node ID, an update target line ID, and slot information. The transmission source node ID is an identifier of a node (the node A in this example) that is the transmission source of the response message.

The update target line ID is an identifier (#1 to #k) of the clockwise line or the counterclockwise line of the update target of the slot information. The update target line ID indicates a line through which a frame signal including a slot in which the decreased traffic of the terminal 3 is accommodated is transmitted.

The slot information is slot information on the transmitting side of the frame signal transmitted to the clockwise line or the counterclockwise line indicated by the update target line ID. The transmission control unit CNT updates the slot information based on the slot information and the update target line ID in the response message.

In this way, in the transmission device 1 of the nodes A and C, the transmission control unit CNT generates an instruction message or a response message regarding the update of the slot information due to the increase or decrease of the traffic of the terminal 3, and inserts such a message into the overhead H of the frame signal.

Therefore, when the accommodation destination node of the traffic of the terminal 3 switches from the nodes A and B to the nodes B and C, the transmission control units CNT of the transmission devices 1 of the nodes A and C may update the slot information in cooperation based on the instruction message and the response message as the traffic increases or decreases.

As a result, the slots allocated to the traffic of the terminal 3 received by the transmission device 1 of the node A are opened and are allocated to traffic newly received by the transmission device 1 of the node C. By changing the slot allocation between the transmission devices 1 of the nodes A and C, the transmission device 1 of the node A may open the bandwidth Ba (see, e.g., FIG. 7) of traffic secured in the frame signal, and the transmission device 1 of the node C may secure the bandwidth Bc (see, e.g., FIG. 8) of traffic in the frame signal.

Therefore, each of the transmission devices 1 of the nodes A and C allocates slots of the frame signal to the traffic of the terminal 3 in advance in preparation for switching the accommodation destination node of the traffic of the terminal 3. Thus, there is no need to secure a bandwidth for accommodating traffic in the frame signal. Therefore, each of the transmission devices 1 of the nodes A and C may efficiently secure the bandwidth in the ring network NW according to the movement of the end user.

### [Configuration Example of Access Device]

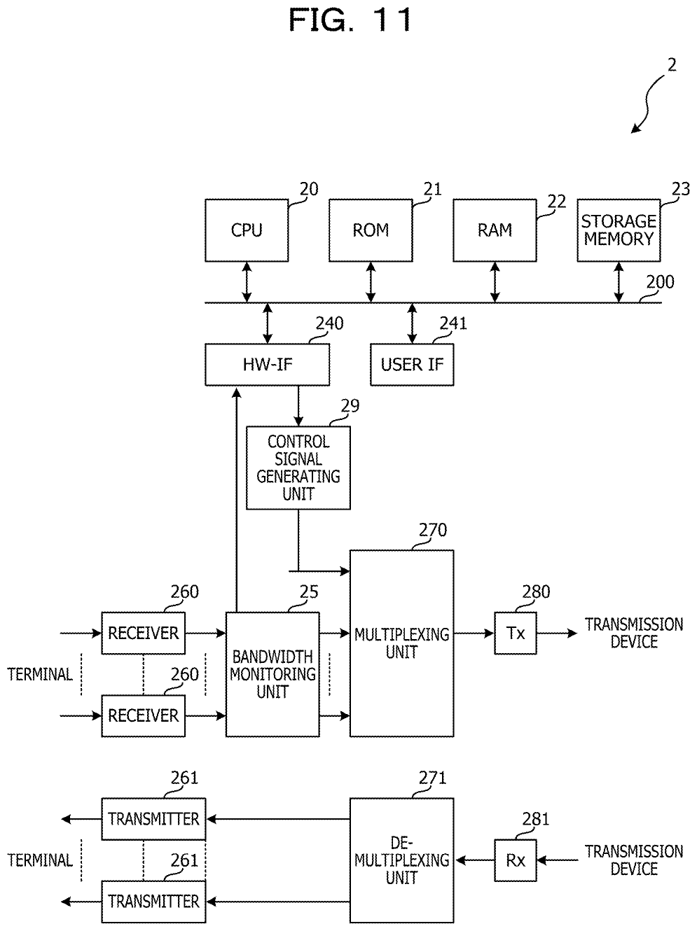

FIG. 11 is a configuration diagram illustrating an example of the access device 2. The access device 2 accommodates the access line of the moving end user's terminal 3. The access device 2 includes a Central Processing Unit (CPU) 20, a Read Only Memory (ROM) 21, a Random Access Memory (RAM) 22, a storage memory 23, a hardware interface unit (HW-IF) 240, and a user interface unit (user IF) 241. The CPU 20 is connected to the ROM 21, the RAM 22, the storage memory 23, the HW-IF 240, and the user IF 241 via a bus 200 so that signals may be input and output.

The ROM 21 stores a program that drives the CPU 20. The RAM 22 functions as a working memory of the CPU 20. The storage memory 23 stores information related to the state management of the access device 2, and the communication control. The user IF 241 processes communication between a terminal device of the administrator of the access device 2 and the CPU 20 of the access device 2.

The access device 2 further includes a plurality of receivers 260, a plurality of transmitters 261, a bandwidth monitoring unit 25, a control signal generating unit 29, a multiplexing unit 270, a de-multiplexing unit 271, a transmitting port (Tx) 280, and a receiving port (Rx) 281. The HW-IF 240 processes communication among the CPU 20, the bandwidth monitoring unit 25, and the control signal generating unit 29. The HW-IF 240, the user IF 241, the multiplexing unit 270, the de-multiplexing unit 271, the bandwidth monitoring unit 25, and the control signal generating unit 29 are a circuit composed of hardware such as a Field Programmable Gate Array (FPGA) and an Application Specified Integrated Circuit (ASIC).

Each receiver 11 includes, for example, a photodiode, a 64B/66B decoder, and the like and receives an Ethernet signal from the terminal 3 via an access line. Each receiver 11 outputs the Ethernet signal to the bandwidth monitoring unit 25.

The bandwidth monitoring unit 25 monitors the bandwidth of the Ethernet signal from the terminal 3 for each receiver 11. The bandwidth monitoring unit 25 notifies the CPU 20 of an increase or decrease in the bandwidth of the Ethernet signal. For example, the bandwidth monitoring unit 25 extracts a byte string of the Ethernet signal and detects a change in the number of IDLE codes and the number of data codes of the 64B/66B code of a Physical Coding Sublayer (PCS) with a comparator or the like to detect the increase or decrease in the bandwidth. The bandwidth monitoring unit 25 outputs an Ethernet signal to the multiplexing unit 270.

The multiplexing unit 270 multiplexes the Ethernet signals from the plurality of receivers 11 and outputs the multiplexed Ethernet signals to the transmitting port 280. The transmitting port 280 includes, for example, a laser diode, a 64B/66B encoder, and the like and transmits a multiplexed Ethernet signal to the transmission device 1.

The receiving port 281 includes, for example, a photodiode, a 64B/66B decoder, and the like. The receiving port 281 receives the multiplexed Ethernet signal and outputs the received Ethernet signal to the de-multiplexing unit 271. The de-multiplexing unit 271 separates each Ethernet signal and outputs the separated Ethernet signal to the plurality of transmitters 261. The transmitter 261 includes, for example, a laser diode, a 64B/66B encoder, and the like and transmits the Ethernet signal to the terminal 3 via an access line.

When receiving the notification of the increase or decrease of the traffic of the terminal 3 from the bandwidth monitoring unit 25, the CPU 20 instructs the control signal generating unit 29 to generate a control signal including traffic information indicating the increase or decrease of the traffic. The control signal generating unit 29 generates the control signal according to the instruction of the CPU 20 and outputs the generated control signal to the multiplexing unit 270. The multiplexing unit 270 multiplexes the control signal together with the Ethernet signal and outputs the control signal to the transmitting port 280. As a result, the transmission device 1 acquires the traffic information.

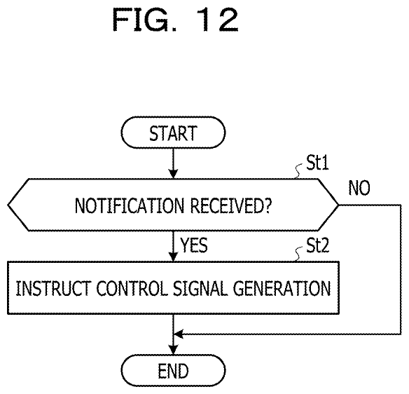

FIG. 12 is a flowchart illustrating an example of a control signal transmission process of the access device 2. The CPU 20 determines whether the notification has been received from the bandwidth monitoring unit 25 (operation St1). When it is determined that the notification has not been received (“No” in operation St1), the CPU 20 ends the process.

When it is determined that the notification has been received (“Yes” in operation St1), the CPU 20 instructs the control signal generating unit 29 to generate the control signal including the traffic information indicating the increase or decrease in the traffic of the terminal 3 (operation St2). At this time, the CPU 20 may proceed to an operation mode different from the normal communication process.

In this way, the bandwidth monitoring unit 25 detects the decrease or increase in the traffic of the terminal 3 as the end user moves. The bandwidth monitoring unit 25 may, for example, compare the bandwidth of the traffic with a predetermined threshold value to determine the increase or decrease according to the comparison result.

### [Configuration Example of Transmission Device]

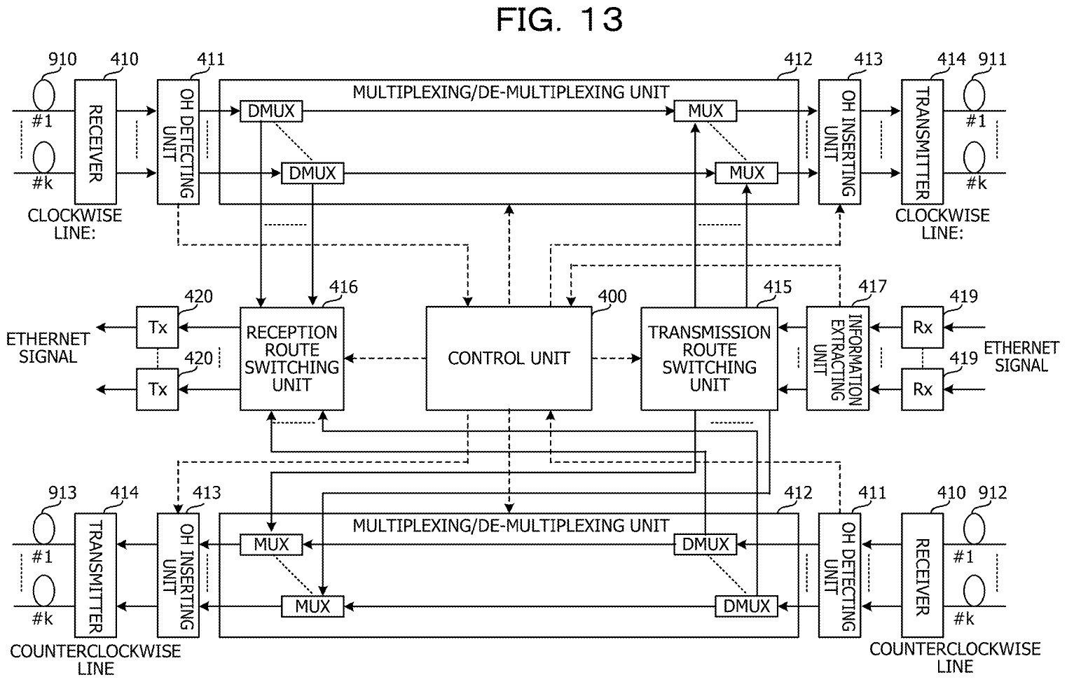

FIG. 13 is a configuration diagram illustrating an example of the transmission device 1. The transmission device 1 includes a control unit 400, a receiver 410, a transmitter 414, a receiving port (Rx) 419, a transmitting port (Tx) 420, an overhead (OH) detecting unit 411, an overhead (OH) inserting unit 413, a multiplexing/de-multiplexing unit 412, a transmission route switching unit 415, a reception route switching unit 416, and an information extracting unit 417.

The control unit 400 corresponds to the transmission control unit CNT, and the receiving port 419 and the transmitting port 420 correspond to the ports P1 to Pn. The receiver 410, the transmitter 414, the multiplexing/de-multiplexing unit 412, the OH detecting unit 411, and the OH inserting unit 413 are provided two by two corresponding to each of the clockwise lines #1 to #k and the counterclockwise lines #1 to #k. The two sets of transmitter 414 and receiver 410 correspond to the network interface units NW-IF #1 and #2. Further, the two sets of multiplexing/de-multiplexing units 412, OH detecting units 411, OH inserting units 413, transmission route switching units 415, and reception route switching units 416 correspond to the frame processing unit FP.

Each of the receiving ports 419 receives the multiplexed Ethernet signal from the access device 2 and outputs the received Ethernet signal to the information extracting unit 417. The receiving port 419 includes, for example, a photodiode, a demodulator, and the like.

The information extracting unit 417 extracts the control signal including the traffic information from the multiplexed Ethernet signal and outputs the extracted control signal to the control unit 400. The traffic information is used to control the bandwidth of the frame signal as described above. In addition, the information extracting unit 417 outputs each Ethernet signal to the transmission route switching unit 415. The information extracting unit 417 is an example of an acquiring unit that acquires the traffic information indicating the increase or decrease in the traffic.

The Ethernet signal is input to the reception route switching unit 416 from the multiplexing/de-multiplexing unit 412 corresponding to a path of the reception source of frame signal from each of two adjacent nodes A to E and X (hereinafter, referred to as a “reception path”). The reception route switching unit 416 outputs Ethernet signals to the transmitting port 420.

Each of the transmitting ports 420 multiplexes the Ethernet signals and transmits the multiplexed Ethernet signals to the access device 2. Each transmitting port 420 has, for example, a laser diode, a modulator, and the like.

The receiver 410 of one side is connected to a transmission path 910 of the clockwise lines #1 to #k, and the other side receiver 410 is connected to a transmission path 912 of the counterclockwise lines #1 to #k. Further, the transmitter 414 of one side is connected to a transmission path 911 of the clockwise lines #1 to #k, and the other side transmitter 414 is connected to a transmission path 913 of the counterclockwise lines #1 to #k. For example, the transmission device 1 of the node B is connected to the node A via the transmission paths 910 and 913 and is connected to the node B via the transmission paths 911 and 912. Each of the transmission paths 910 to 913 is provided as many as the number of clockwise lines #1 to #k and counterclockwise lines #1 to #k.

The receiver 410 has, for example, a photodiode. The receiver 410 receives a frame signal from each of the transmission paths 910 and 912 and outputs the received frame signal to the OH detecting unit 411.

The OH detecting unit 411 detects the overhead H from the frame signal and outputs the detected overhead H to the control unit 400. As a result, the control unit 400 executes various controls via a control channel. The OH detecting unit 411 outputs data in the slot region of the frame signal to the multiplexing/de-multiplexing unit 412.

The multiplexing/de-multiplexing unit 412 has the same number of multiplexing circuits MUX and de-multiplexing circuits DMUX as the clockwise lines #1 to #k and counterclockwise lines #1 to #k. Each multiplexing circuit MUX is provided after each de-multiplexing circuit DMUX when viewed from the OH detecting unit 411.

Each de-multiplexing circuit DMUX separates the Ethernet signal from the data in the slot region input from the OH detecting unit 411. The separated Ethernet signal is output to the transmitting port 420 and is transmitted from the transmitting port 420 to the access device 2. The de-multiplexing circuit DMUX performs a de-multiplexing process so that the Ethernet signal is taken out from the slot at a timing instructed by the control unit 400. When the Ethernet signal is separated from the slot of the frame signal, the control unit 400 sets a de-multiplexing timing in the de-multiplexing circuit DMUX based on the receiving side slot information.

The multiplexing circuit MUX multiplexes the Ethernet signal input from the receiving port 419 with the data in the slot region input from the de-multiplexing circuit DMUX. The multiplexing circuit MUX performs a multiplexing process so that the Ethernet signal is accommodated in the slot at the timing instructed by the control unit 400. When the Ethernet signal is accommodated in the slot of the frame signal transmitted to the node X, the control unit 400 sets an accommodation timing in the multiplexing circuit MUX based on the transmitting side slot information.

The OH inserting unit 413 generates an overhead H including various control messages input from the control unit 400 and inserts the generated overhead H into a frame signal. The OH inserting unit 413 outputs the frame signal to the transmitter 414.

The transmitter 414 has, for example, an LD that performs an electrical-optical conversion and the like. The transmitter 414 transmits a frame signal to the transmission paths 911 and 913. The OH detecting unit 411, the OH inserting unit 413, the multiplexing/de-multiplexing unit 412, the transmission route switching unit 415, the reception route switching unit 416, the information extracting unit 417, the receiving port 419, and the transmitting port 420 is a circuit composed of hardware such as a FPGA or an ASIC.

The transmission route switching unit 415 selects the transmission destination path (hereinafter, referred to as a “transmission path”) of the frame signal by selecting the output destination of the Ethernet signal from each receiving port 419, from two multiplexing/de-multiplexing units 412 corresponding to the clockwise lines #1 to #k and the counterclockwise lines #1 to #k, respectively. For example, in the node B, the transmission route switching unit 415 selects one of the path on the node A side and the path on the node C side, as the transmission path. At this time, the transmission route switching unit 415 switches the multiplexing circuit MUX of the output destination of the Ethernet signal according to the clockwise line ID and the counterclockwise line ID of the transmitting side slot information. The control unit 400 controls the transmission route switching unit 415 according to the path setting of the frame signal.

The reception route switching unit 416 selects the reception path of the frame signal by selecting the output destination of the Ethernet signal from each transmitting port 420, from the two multiplexing/de-multiplexing units 412 corresponding to the clockwise lines #1 to #k and the counterclockwise lines #1 to #k, respectively. For example, in the node B, the reception route switching unit 416 selects one of the path on the node A side and the path on the node C side, as the reception path. At this time, the reception route switching unit 416 switches the de-multiplexing circuit DMUX of the output destination of the Ethernet signal according to the clockwise line ID and the counterclockwise line ID of the receiving side slot information.

The control unit 400 performs a slot information setting process and a slot information changing process and a slot allocation process based on the slot information. As described above, the control unit 400 generates the collection message, sets the slot information by receiving the setting message, and allocates the slots to the traffic of the terminal 3. Further, the control unit 400 updates the slot information so that the number of slots increases or decreases, by transmitting and receiving the instruction message and the response message according to the increase or decrease in the traffic of the terminal 3.

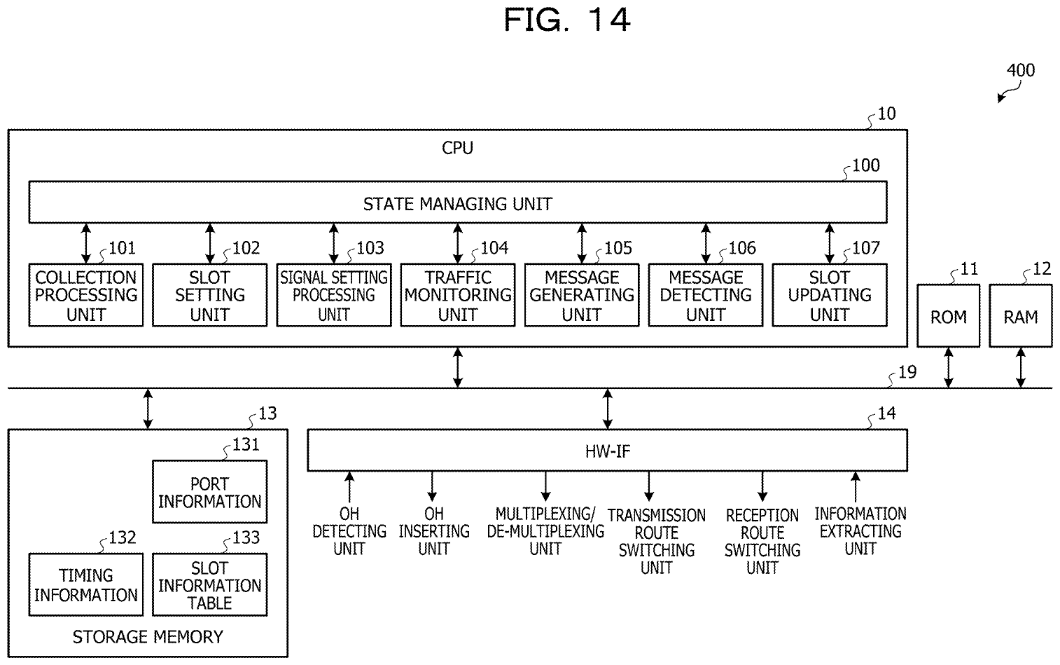

FIG. 14 is a configuration diagram illustrating an example of the control unit 400. The control unit 400 includes a CPU 10, a ROM 11, a RAM 12, a storage memory 13, and a hardware interface unit (HW-IF) 14. The CPU 10 is connected to the ROM 11, the RAM 12, the storage memory 13, and the HW-IF 14 via a bus 19 so that signals may be input and output.

The ROM 11 stores a program that drives the CPU 10. The RAM 12 functions as a working memory of the CPU 10. The HW-IF14 relays communication among the CPU 10, the OH detecting unit 411, the OH inserting unit 413, the multiplex/de-multiplexing unit 412, the transmission route switching unit 415, the reception route switching unit 416, and the information extracting unit 417.

When reading the program from the ROM 11, the CPU 10 forms, as its functions, a state managing unit 100, a collection processing unit 101, a slot setting unit 102, a signal setting processing unit 103, a traffic monitoring unit 104, a message generating unit 105, a message detecting unit 106, and a slot updating unit 107. The state managing unit 100, the collection processing unit 101, the slot setting unit 102, the signal setting processing unit 103, the traffic monitoring unit 104, the message generating unit 105, the message detecting unit 106, and the slot updating unit 107 may be configured by circuits such as a FPGA. Further, the storage memory 13 stores port information 131, timing information 132, and slot information table 133.

The state managing unit 100 manages the state of the transmission device 1 and instructs the collection processing unit 101, the slot setting unit 102, the signal setting processing unit 103, the traffic monitoring unit 104, the message generating unit 105, and the message detecting unit 106 to operate according to the state. The state managing unit 100 executes a sequence according to various messages. The message detecting unit 140 detects various messages from the overhead H detected by the OH detecting unit 411 and outputs the detected messages to the CPU 10.

The collection processing unit 101 executes a collection process of the port information 131. The collection processing unit 101 reads the port information 131 from the storage memory 13 and outputs the read port information 131 to the message generating unit 141. The message generating unit 141 generates a collection message and assigns the port information to the collection message. The message generating unit 141 outputs the collection message to the OH inserting unit 413. As a result, the message generating unit 141 assigns the port information 131 to the overhead H of the frame signal.

When the collection message is detected in the message detecting unit 140, the collection processing unit 101 adds the port information 131 of its own nodes A to E to the collection message. At this time, the port information 131 of the other nodes A to E included in the collection message remains included in the collection message as it is. Therefore, the port information 131 of each of the nodes A to E is assigned to one collection message.

When the setting message is detected by the message detecting unit 140, the slot setting unit 102 acquires the transmitting side slot information and the receiving side slot information from the setting message. The slot setting unit 102 stores the transmitting side slot information and the receiving side slot information in the slot information table 133 and sets slots by setting the timing information 132 based on the transmitting side slot information and the receiving side slot information.

The timing information 132 indicates a timing at which the Ethernet signal is accommodated in the slots for each of the clockwise lines #1 to #k and the counterclockwise lines #1 to #k in the multiplexing/de-multiplexing unit 412, and a timing at which the Ethernet signal is separated from the slots. The timing information 132 is, for example, information among the transmitting side slot information and the receiving side slot information, in which the slot ID corresponding to the corresponding node ID is replaced with the multiplexing and de-multiplexing time in the multiplexing/de-multiplexing unit 412 based on the overhead detection time. The signal setting processing unit 103 controls the multiplexing timing and the de-multiplexing timing of the Ethernet signal with respect to the multiplexing/de-multiplexing unit 412 based on the timing information 132.

As a result, each slot of the frame signal transmitted to the node X and each slot of the frame signal received from the node X are allocated to the Ethernet signal.

The traffic monitoring unit 104 monitors the traffic of the terminal 3 received from the access device 2 based on the traffic information input from the information extracting unit 417. As a monitoring result, the traffic monitoring unit 104 notifies the state managing unit 100 of, for example, the increase or decrease in the traffic of the terminal 3.

When being notified of the increase in the traffic of the terminal 3, the state managing unit 100 moves the state of the transmission device 1 to the update instruction mode and instructs the message generating unit 105 to generate the instruction message. The message generating unit 105 reads the transmitting side slot information of the node in which the transmission device 1 is installed, from the slot information table 133 and assigns the read information to the instruction message.

The message generating unit 105 outputs the instruction message to each of two OH inserting units 413. As a result, the instruction message is transmitted to the adjacent nodes A to E and X on both sides of the nodes A to E of the transmission device 1.

Further, when being notified of the decrease in the traffic of the terminal 3, the state managing unit 100 moves the state of the transmission device 1 to the update response mode when the message detecting unit 106 receives the instruction message, and instructs the message generating unit 105 to generate the response message. The message generating unit 105 reads the transmitting side slot information of the nodes A to E in which the transmission device 1 is installed, from the slot information table 133 and assigns the read information to the instruction message. Further, the message generating unit 105 assigns an identifier of the clockwise line or counterclockwise line of the frame signal including the slots of the accommodation destination of the decreased traffic, to the response message, as an update target line ID.

The message generating unit 105 outputs the response message to the OH inserting unit 413 on the nodes A to E side indicated by the transmission source node ID of the instruction message. As a result, the response message is transmitted to the adjacent nodes A to E and X on the transmission source side of the instruction message.

The slot updating unit 107 updates the slot information table 133 based on the slot information assigned to the instruction message or the response message detected by the message detecting unit 106. According to the instruction message, the slot updating unit 107 deletes the slots of the clockwise line or the counterclockwise line that transmits the frame signal in which the decreased traffic was accommodated, from the slot information table 133. That is, the slot updating unit 107 updates the slot information so that the number of slots decreases according to the instruction message.

Further, the slot updating unit 107 allocates the slots of the clockwise line or the counterclockwise line indicated by the update target line ID, to the increased traffic according to the response message. That is, the slot updating unit 107 updates the slot information so that the number of slots increases according to the response message.

As a result, as described above, the transmission device 1 of the node C accommodating the traffic of the terminal 3 before the movement and the transmission device 1 of the node A accommodating the traffic of the terminal 3 after the movement may update the slot information in cooperation by transmission and reception of the instruction message and the response message.

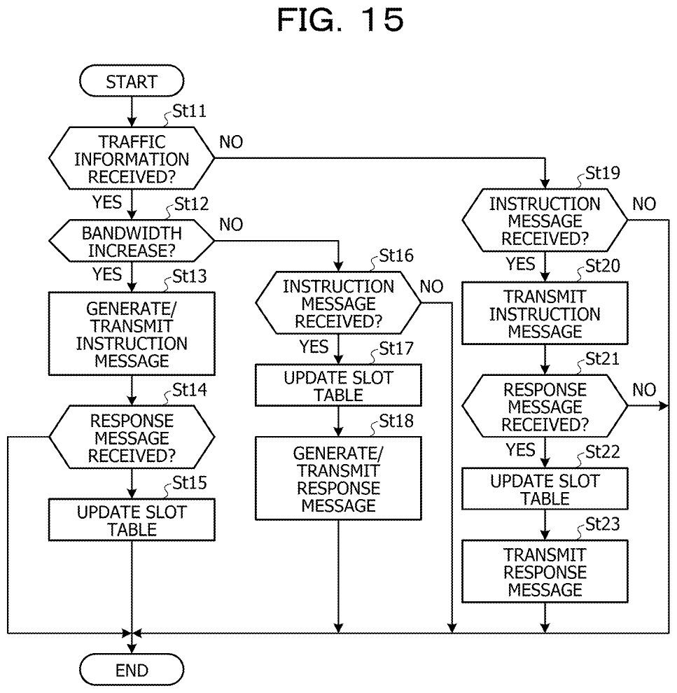

FIG. 15 is a flowchart illustrating an example of processing of the instruction message and the response message. The traffic monitoring unit 104 determines whether the traffic information has been received from the access device 2 (operation St11). Next, the traffic monitoring unit 104 determines whether the traffic information indicates an increase or decrease in the bandwidth of the traffic (operation St12).

The processes of the subsequent operations St13 to St15 are executed by the transmission device 1 of the node C in the example of FIGS. 7 to 9, and the processes of the subsequent operations St16 to St18 are executed by the transmission device 1 of the node A in the example of FIGS. 7 to 9. Further, the processes of the subsequent operations St19 to St23 are executed by the transmission device 1 of the node B in the example of FIGS. 7 to 9.

When the traffic information indicates the increase in the bandwidth of the traffic (“Yes” in operation St12), the message generating unit 105 generates an instruction message and outputs the instruction message to the OH inserting unit 413 to transmit the instruction message to the adjacent nodes A to E and X (operation St13). Next, the message detecting unit 106 determines whether the response message has been received by detecting the “State” of a message in the overhead H by the OH detecting unit 411 (operation St14).

When it is determined that the response message has not been received (“No” in operation St14), the process ends. When it is determined that the response message has been received (“Yes” in operation St14), the slot updating unit 107 updates the slot information in the slot information table 133 so that slots are allocated to the increased traffic (operation St15).

When the traffic information indicates the decrease in the bandwidth of the traffic (“No” in operation St12), the message detecting unit 106 determines whether the instruction message has been received by detecting the “State” of a message in the overhead H by the OH detecting unit 411 (operation St16).

When it is determined that the instruction message has not been received (“No” in operation St16), the process ends. When it is determined that the instruction message has been received (“Yes” in operation St16), the slot updating unit 107 updates the slot information in the slot information table 133 so that the slots allocated to the increased traffic is deleted (operation St17). Next, the message generating unit 105 transmits the response message to the adjacent nodes A to E and X by generating the response message and outputting the generated response message to the OH inserting unit 413 (operation St18).

When it is determined that the traffic information has not been received (“No” in operation St11), the message detecting unit 106 determines whether the instruction message has been received by detecting the “State” of a message in the overhead H by the OH detecting unit 411 (operation St19). When it is determined that the instruction message has not been received (“No” in operation St19), the process ends.

When it is determined that the instruction message has been received (“Yes” in operation St19), the message generating unit 105 transmits the instruction message to the adjacent nodes A to E and X by outputting the instruction message to the OH inserting unit 413 (“Yes” in operation St20).

Next, the message detecting unit 106 determines whether the response message has been received by detecting the “State” of a message in the overhead H by the OH detecting unit 411 (operation St21). When it is determined that the response message has not been received (“No” in operation St21), the process ends.

When it is determined that the response message has been received (“Yes” in operation St21), the slot updating unit 107 updates the slot information of the transmission source nodes A to E of the instruction message and the response message based on the slot information assigned to the instruction message and the response message (operation St22). Next, the message generating unit 105 transmits the response message to the adjacent nodes A to E and X by outputting the response message to the OH inserting unit 413 (operation St23).

In this way, the processing of the instruction message and the response message is executed. The message detecting unit 106 updates the number of hops when transmitting the instruction message, and discards the instruction message when the number of hops exceeds the maximum number of hops.

In this way, when the traffic information indicates an increase in the traffic, the control unit 400 generates the instruction message instructing the other nodes A to E with the decreased traffic to update the slot information so that the number of slots decreases, and inserts the instruction message into the overhead H. Further, when the response message to the instruction message is received from the overhead H, the control unit 400 updates the slot information so that the number of slots increases. This operation corresponds to the operation of the control unit 400 of the transmission device 1 of the node C in the above example.

Further, when the traffic information indicates a decrease in the traffic, the control unit 400 updates the slot information so that the number of slots decreases when the instruction message to update the slot information from the other nodes A to E with the increased traffic is received from the overhead H. Further, the control unit 400 generates the response message to the instruction message and inserts the generated response message into the overhead H. This operation corresponds to the operation of the control unit 400 of the transmission device 1 of the node A in the above example.

Therefore, after the transmission devices 1 of the nodes A to E with the decreased traffic decrease the number of slots, the transmission devices 1 of the nodes A to E with the increased traffic may increase the number of slots. Therefore, there is no need for the transmission devices 1 of the nodes A to E with the decreased traffic and the nodes A to E with the increased traffic to secure slots for accommodating the traffic at the same time.

### [Example of Allocating Slots to Free Bandwidth]

In the above example, the transmission device 1 increases or decreases the number of slots allocated to the traffic of the terminal 3 according to the increase or decrease of the traffic, but the present disclosure is not limited thereto. As described below, the transmission device 1 may increase or decrease the number of slots allocated to a free bandwidth among the bandwidths of the access line for transmitting the traffic of the terminal 3, according to the increase or decrease of the traffic.

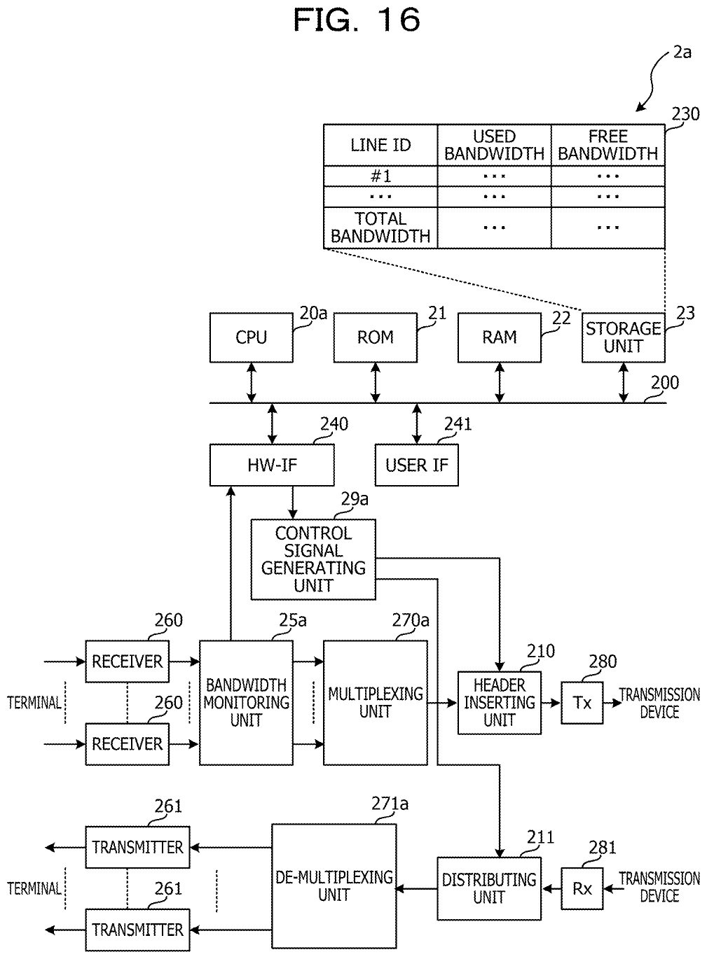

FIG. 16 is a configuration diagram illustrating an example of another access device 2a. In FIG. 16, the configurations common to FIG. 11 are denoted by the same symbols, and the explanation thereof will not be repeated.

The access device 2a notifies the transmission device 1 of the traffic of the terminal 3 and a free bandwidth of the access line. The access device 2a includes a CPU 20a, a ROM 21, a RAM 22, a storage memory 23, a HW-IF 240, and a user IF 241. The access device 2a further includes a header inserting unit 210, a distributing unit 211, a plurality of receivers 260, a plurality of transmitters 261, a bandwidth monitoring unit 25a, a control signal generating unit 29a, a multiplexing unit 270a, a de-multiplexing unit 271a, a transmitting port (Tx) 280, and a receive port (Rx) 281. The header inserting unit 210, the distributing unit 211, the HW-IF 240, the user IF 241, the multiplexing unit 270a, the de-multiplexing unit 271a, the bandwidth monitoring unit 25a, and the control signal generating unit 29a are a circuit composed of hardware such as a FPGA and an ASIC.

The bandwidth monitoring unit 25a monitors a used bandwidth and a free bandwidth of Ethernet signals from the terminal 3 for each receiver 11 connected to the individual access line. The bandwidth monitoring unit 25a notifies the CPU 20a of the used bandwidth and the free bandwidth of traffic of the Ethernet signals. The Ethernet signals are input from the bandwidth monitoring unit 25a to the multiplexing unit 270a and are multiplexed into a multiplex signal.

The CPU 20a registers the used bandwidth and the free bandwidth for each access line of the receiver 260 in a bandwidth table 230 in the storage memory 23. A line ID for identifying an access line, a used bandwidth, and a free bandwidth are registered in the bandwidth table 230. Further, the CPU 20a calculates the total of the used bandwidth and the free bandwidth of each access line and registers the calculated total in the bandwidth table 230. The CPU 20a outputs data of the bandwidth table 230 to the control signal generating unit 29a.

Further, when the used bandwidth and the free bandwidth in the bandwidth table 230 change from initial values, the CPU 20a instructs the control signal generating unit 29a to generate a control signal including traffic information indicating an increase or decrease in traffic.

The control signal generating unit 29a generates the control signal including the traffic information and the bandwidth table 230 according to the instruction of the CPU 20a and outputs the control signal to the header inserting unit 210. The header inserting unit 210 generates the Shim header of the “Flex Ethernet” technology based on the bandwidth table 230. The Shim header indicates allocation of slots in the multiplex signal to the used bandwidth and free bandwidth of the traffic, like the slot information. The header inserting unit 210 assigns the traffic information and the Shim header to the multiplex signal output from the multiplexing unit 270a.

Further, the control signal generating unit 29a outputs the data of the bandwidth table 230 to the distributing unit 211. The distributing unit 211 determines the distribution of the Ethernet signals for each access line from the slots of the multiplex signal input from the receiving port 281, based on the bandwidth table 230. The de-multiplexing unit 271a separates the Ethernet signals for each transmitter 261 from the multiplex signal according to the determination of the distributing unit 211.

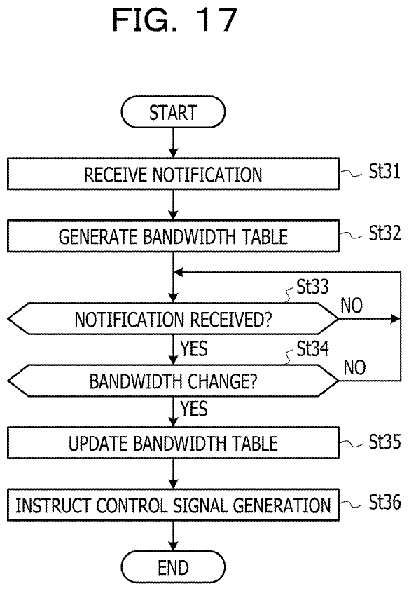

FIG. 17 is a flowchart illustrating an example of transmission process of the control signal of another access device 2a. When the access device 2a is started, the CPU 20a receives a notification of initial values of the used bandwidth and the free bandwidth of the traffic from the bandwidth monitoring unit 25a (operation St31). Next, the CPU 20a generates the bandwidth table 230 from the used bandwidth and the free bandwidth of the traffic (operation St32).

Next, the CPU 20a determines whether a new notification has been received from the bandwidth monitoring unit 25a (operation St33). When it is determined that the new notification has not been received (“No” in operation St33), the process of operation St33 is executed again. When it is determined that the new notification has been received (“No” in operation St33), the CPU 20a determines whether the used bandwidth and the free bandwidth of the traffic have changed from the initial values (operation St34). When it is determined that there is no change (“No” in operation St34), the process of operation St33 is executed again.

When it is determined that there is a change (“Yes” in operation St34), the CPU 20a updates the bandwidth table 230 according to the new notification (operation St35). Next, the CPU 20a instructs the control signal generating unit 29a to generate a control signal (operation St36). As a result, the information extracting unit 417 of the transmission device 1 acquires the traffic information and the Shim header from the control signal transmitted by the access device 2a. The Shim header is an example of free bandwidth information indicating a free bandwidth among the bandwidths of the access line that transmits the traffic.

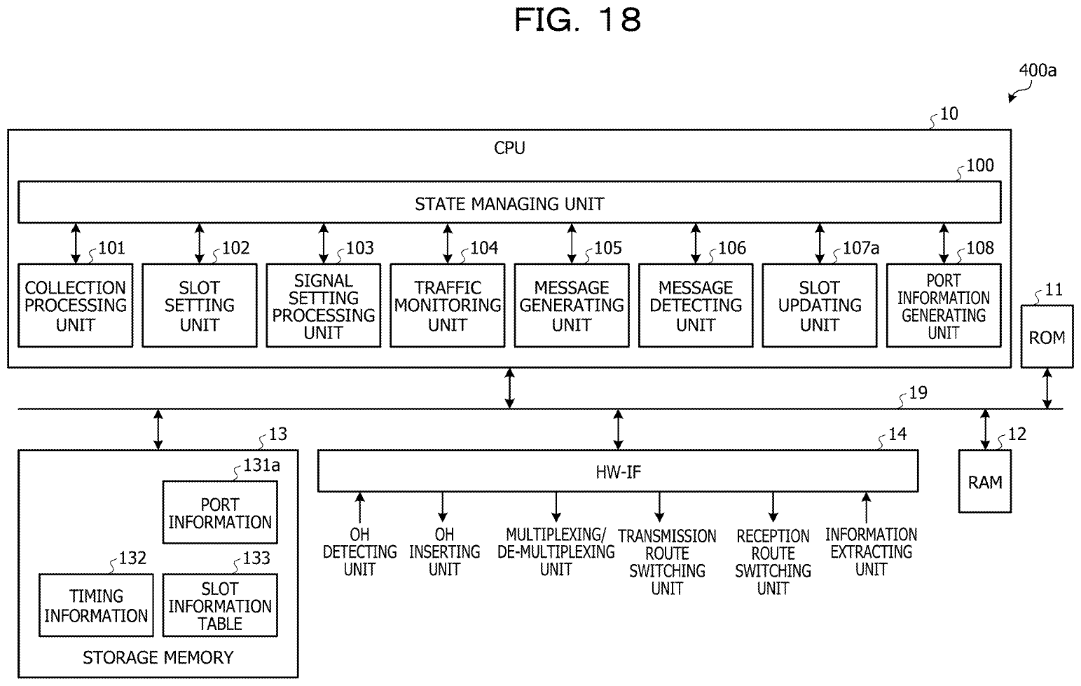

FIG. 18 is a configuration diagram illustrating an example of another control unit 400a. In FIG. 18, the configurations common to FIG. 14 are denoted by the same symbols, and the explanation thereof will not be repeated. The control unit 400a is provided in the transmission device 1, instead of the control unit 400, and corresponds to the transmission control unit CNT.

When reading a program from the ROM 11, the CPU 10 forms, as its functions, a state managing unit 100, a collection processing unit 101, a slot setting unit 102, a signal setting processing unit 103, a traffic monitoring unit 104, a message generating unit 105, a message detecting unit 106, a slot updating unit 107a, and a port information generating unit 108. The state managing unit 100, the collection processing unit 101, the slot setting unit 102, the signal setting processing unit 103, the traffic monitoring unit 104, the message generating unit 105, the message detecting unit 106, the slot updating unit 107a, and the port information generating unit 108 may be configured by circuits such as and FPGA and the like.

The port information generating unit 108 generates port information 131a from the information of the Shim header and stores the port information 131a in the storage memory 13. The port information 131a is different from the above-mentioned port information 131 in that the bandwidth for each port includes a free bandwidth in addition to the used bandwidth of the traffic of the Ethernet signal. That is, the port information generating unit 108 sets the total of the used bandwidth and the free bandwidth of the bandwidth table 230 as the bandwidth of the port information 131a.

Therefore, the port information 131a indicates allocation of the Ethernet signals “a” to “e” and the free bandwidth of the access line to the ports P1 to Pn in the nodes A to E. The collection processing unit 101 collects the port information 131a from the storage memory 13, and the message generating unit 105 assigns the port information 131a to the collection message. As a result, the slots of the frame signal are allocated to the used bandwidth and the free bandwidth of the access line.

Further, the slot updating unit 107a updates the slot information table 133 based on the slot information assigned to the instruction message or the response message detected by the message detecting unit 106. The slot information assigned to the instruction message and the response message indicates the slots allocated to the used bandwidth and the free bandwidth of the traffic. Therefore, when the traffic increases or decreases, the slot updating unit 107a updates the slot information so that not only the number of slots allocated to the traffic increases or decreases, but also the number of slots allocated to the free bandwidth increases or decreases.

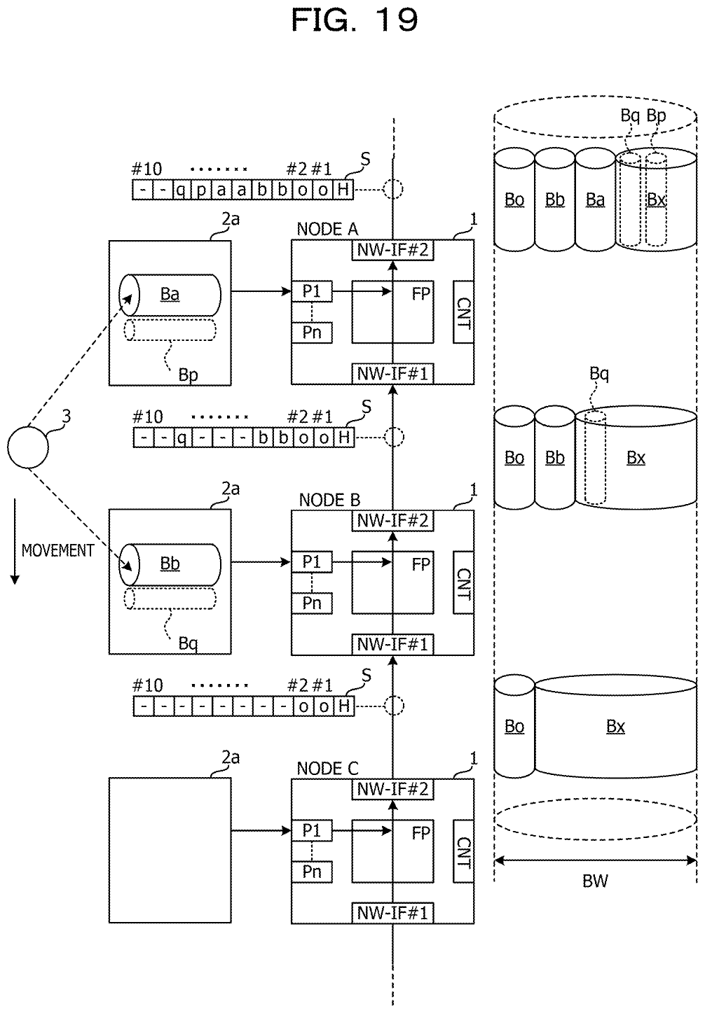

FIG. 19 is a diagram illustrating a bandwidth BW of the ring network NW before movement of the terminal 3 when slots are allocated to a free bandwidth. In FIG. 19, the configurations common to FIG. 7 are denoted by the same symbols, and the explanation thereof will not be repeated.

The transmission device 1 of the node A receives the Ethernet signal “a” of the bandwidth Ba from the access device 2a. The free bandwidth of the access line in which the Ethernet signal “a” is accommodated is Bp. Further, the transmission device 1 of the node B receives the Ethernet signal “b” of the bandwidth Bb from the access device 2a. The free bandwidth of the access line in which the Ethernet signal “b” is accommodated is Bq.

The port P1 of the transmission device 1 of the node B receives the Ethernet signal “b” from the access device 2a. The transmission control unit CNT updates the slot information so that the slots #3 and #4 are allocated to the Ethernet signal “b” and the slot #8 is allocated to the free bandwidth Bq (see, e.g., the symbol q). The frame processing unit FP accommodates the Ethernet signal “b” in the slots #3 and #4 of the frame signal S received from the node C, based on the slot information. The network interface unit NW-IF #2 transmits the frame signal S to the transmission device 1 of the adjacent node A.

The bandwidth BW of a predetermined counterclockwise line between the transmission devices 1 of the nodes A and B includes the bandwidth Bo of the Ethernet signal “o,” the bandwidth Bb of the Ethernet signal “b,” and an unused bandwidth Bx. The unused bandwidth Bx includes the free bandwidth Bq.

The port P1 of the transmission device 1 of the node A receives the Ethernet signal “a” from the access device 2a. The transmission control unit CNT updates the slot information so that the slots #5 and #6 are allocated to the Ethernet signal “b” and the slot #7 is allocated to the free bandwidth Bp (see, e.g., the symbol p). The frame processing unit FP accommodates the Ethernet signal “a” in the slots #5 and #6 of the frame signal S received from the node B, based on the slot information. The network interface unit NW-IF #2 transmits the frame signal S to the transmission device 1 of the adjacent node X.

The bandwidth BW of a predetermined counterclockwise line between the transmission devices 1 and 4 of the nodes A and X includes the bandwidth Bo of the Ethernet signal “o,” the bandwidth Bb of the Ethernet signal “b,” the bandwidth Ba of the Ethernet signal “a,” and an unused bandwidth Bx. The unused bandwidth Bx includes the free bandwidths Bq and Bp.

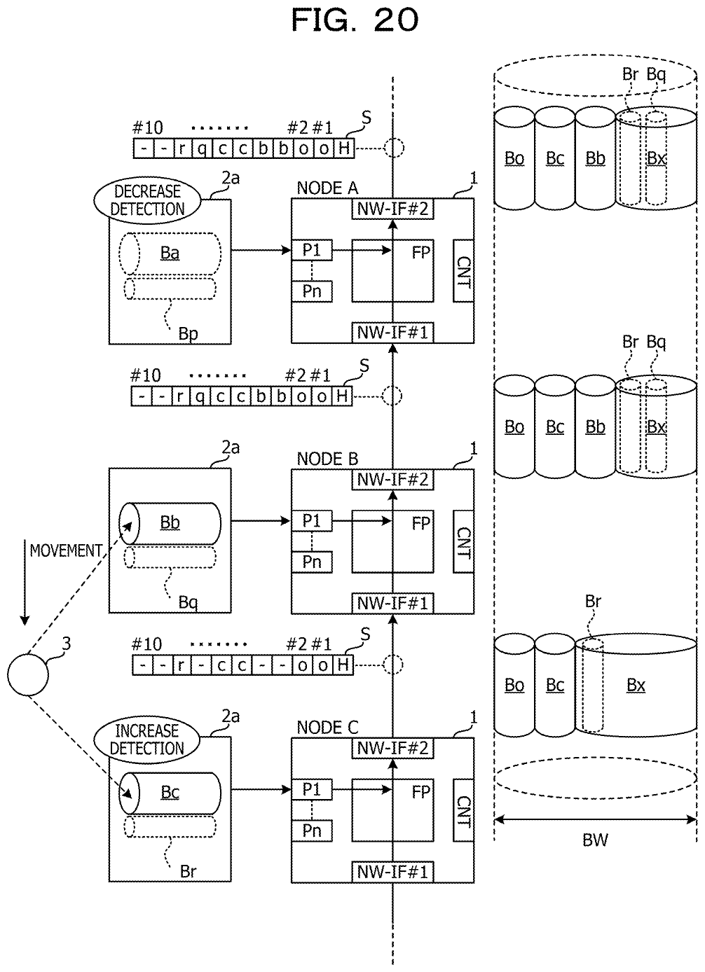

FIG. 20 is a diagram illustrating the bandwidth BW of the ring network NW after movement of the terminal 3 when slots are allocated to a free bandwidth. In FIG. 20, the configurations common to FIG. 8 are denoted by the same symbols, and the explanation thereof will not be repeated.

The transmission device 1 of the node C receives the Ethernet signal “b” of the bandwidth Bb from the access device 2a after the terminal 3 moves. The free bandwidth of the access line in which the Ethernet signal “b” is accommodated is Br. The access device 2 connected to the transmission device 1 of the node C detects a decrease in traffic from the terminal 3 as the terminal 3 moves, and notifies the detected decrease to the transmission device 1 of the node C.

Further, the access device 2a connected to the transmission device 1 of the node A detects an increase in traffic as the terminal 3 moves, and notifies the detected increase to the transmission device 1 of the node A. When receiving the notification from the access device 2a, the transmission control unit CNT of each of the transmission devices 1 of the nodes A and C generates and exchanges an instruction message and a response message, as described above.

When receiving the instruction message from the transmission device 1 of the node C, the transmission control unit CNT of the transmission device 1 of the node A updates the slot information so that the allocation of the slots #5 and #6 to the Ethernet signal “a” and the allocation of the slot #7 to the free bandwidth Bp are deleted. When receiving the response message from the transmission device 1 of the node A, the transmission control unit CNT of the transmission device 1 of the node C updates the slot information so that the slots #5 and #6 are allocated to the Ethernet signal “c” and the slot #7 is allocated to the free bandwidth Br.

The port P1 of the transmission device 1 of the node C receives the Ethernet signal “c” from the access device 2. Based on the updated slot information, the transmission control unit CNT allocates the slots #5 and #6 to the Ethernet signal “c” and allocates the slot #8 to the free bandwidth Br (see, e.g., the symbol r). The frame processing unit FP accommodates the Ethernet signal “c” in the slots #5 and #6 of the frame signal S received from the node D. The network interface unit NW-IF #2 transmits the frame signal S to the transmission device 1 of the adjacent node B.

The bandwidth BW of a predetermined counterclockwise line between the transmission devices 1 of the nodes A and B includes the bandwidth Bo of the Ethernet signal “o,” the bandwidth Bc of the Ethernet signal “c,” and an unused bandwidth Bx. The unused bandwidth Bx includes the free bandwidth Br.

The transmission device 1 of the node B accommodates the Ethernet signal “b” in the slots #3 and #4 of the frame signal S and transmits the Ethernet signal “b” to the transmission device 1 of the adjacent node A, as before the movement of the terminal 3. The bandwidth BW of a predetermined counterclockwise line between the transmission devices 1 of the nodes B and A includes the bandwidth Bo of the Ethernet signal “o,” the bandwidth Bc of the Ethernet signal “c,” the bandwidth Bb of the Ethernet signal “b,” and an unused bandwidth Bx. The unused bandwidth Bx includes the free bandwidths Bq and Br.

The transmission device 1 of the node A transmits the frame signal S to the node X based on the updated slot information without accommodating the Ethernet signal “a” in the frame signal S. The bandwidth BW of a predetermined counterclockwise line between the transmission devices 1 and 4 of the nodes A and X includes the bandwidth Bo of the Ethernet signal “o,” the bandwidth Bc of the Ethernet signal “c,” the bandwidth Bb of the Ethernet signal “b,” and an unused bandwidth Bx. The unused bandwidth Bx includes the free bandwidths Bq and Br.

In this way, the control unit 400 updates the slot information so that one or more slots may be allocated from the slots of the frame signal S to the free bandwidth Br, according to the increase in the traffic of the terminal 3, and updates the slot information so that one or more slots allocated to the free bandwidth Bp may be deleted, according to the decrease in the traffic. Therefore, the transmission device 1 may secure the bandwidths Ba and Bc and the free bandwidths Bp and Br of the traffic in the ring network NW according to the switching of the nodes A to E accommodating the traffic of the terminal 3. Therefore, the bandwidths in the ring network NW may be used more flexibly.

### [Example of Allocating Slots to Another Traffic of Fixed Bandwidth]

The transmission device 1 updates the slot information according to the switching of the accommodation destination nodes A to E of the traffic of the terminal 3, but as described below, the transmission device 1 maintains the slots allocated to the traffic of the terminal 3 when the accommodation destination nodes A to E receive traffic of another terminal fixed to a predetermined node (hereinafter, referred to as “fixed traffic”).

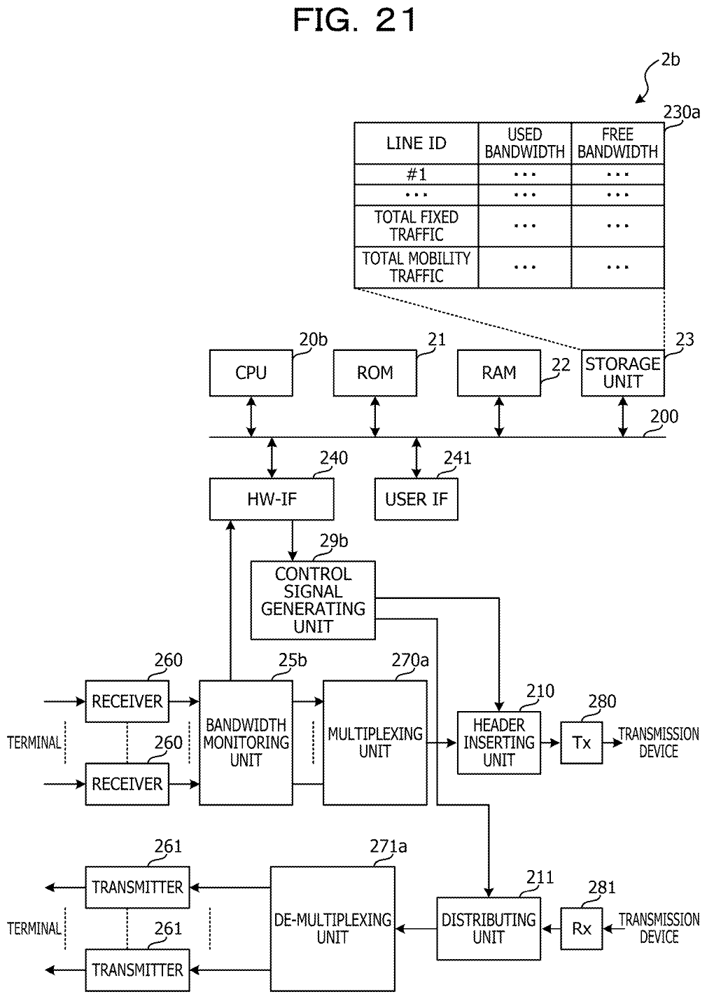

FIG. 21 is a configuration diagram illustrating an example of yet another access device 2b. In FIG. 21, the configurations common to FIG. 16 are denoted by the same symbols, and the explanation thereof will not be repeated.

The access device 2b notifies the bandwidth of the traffic of the terminal 3 and the bandwidth of the fixed traffic of another terminal (not illustrated) to the transmission device 1. The fixed traffic is an example of another traffic in which the accommodation destination node is fixed to the nodes A to E of the transmission device 1. In the following description, the traffic of the terminal 3 is referred to as “mobility traffic.”

The access device 2b has a CPU 20b, a ROM 21, a RAM 22, a storage memory 23, a HW-IF 240, and a user IF 241. The access device 2b further includes a header inserting unit 210, a distributing unit 211, a plurality of receivers 260, a plurality of transmitters 261, a bandwidth monitoring unit 25b, a control signal generating unit 29b, a multiplexing unit 270a, a de-multiplexing unit 271a, a transmitting port (Tx) 280, and a receive port (Rx) 281. The header inserting unit 210, the distributing unit 211, the HW-IF 240, the user IF 241, the multiplexing unit 270a, the de-multiplexing unit 271a, the bandwidth monitoring unit 25b, and the control signal generating unit 29b are a circuit composed of hardware such as a FPGA and an ASIC.

The bandwidth monitoring unit 25b monitors a used bandwidth and a free bandwidth of each of the mobility traffic and the fixed traffic for each receiver 260. The bandwidth monitoring unit 25b notifies the CPU 20b of the used bandwidth and the free bandwidth of each of the mobility traffic and the fixed traffic. The Ethernet signals of each of the mobility traffic and the fixed traffic are input from the bandwidth monitoring unit 25b to the multiplexing unit 270a and are multiplexed into a multiplex signal.

The CPU 20b registers the used bandwidth and the free bandwidth for each receiver 260 in the bandwidth table 230a in the storage memory 23. A line ID for identifying an access line, a used bandwidth, and a free bandwidth are registered in the bandwidth table 230a. Further, the CPU 20b calculates the total of the used bandwidth and the free bandwidth of the mobility traffic and the fixed traffic of each access line and registers the calculated total in the bandwidth table 230a. The CPU 20b outputs the data of the bandwidth table 230 to the control signal generating unit 29b. The CPU 20b may register the used bandwidth and the free bandwidth in the bandwidth table 230a based on the bandwidth setting information input from the user IF 241.

Further, when the used bandwidth and the free bandwidth of the mobility traffic in the bandwidth table 230a change from initial values, the CPU 20b instructs the control signal generating unit 29b to generate a control signal including traffic information indicating an increase or decrease in the mobility traffic.

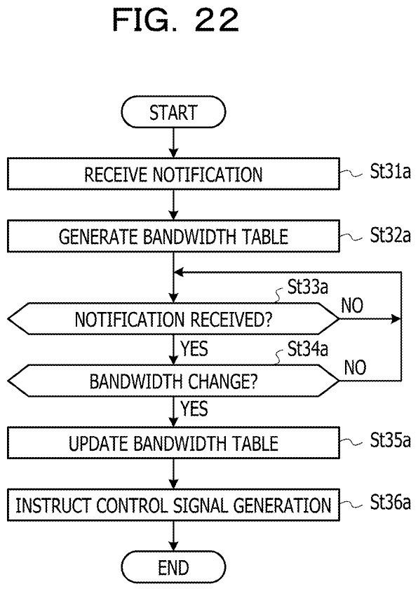

The control signal generating unit 29b generates the control signal including the traffic information and the bandwidth table 230a according to the instruction of the CPU 20b and outputs the control signal to the header inserting unit 210. The header inserting unit 210 assigns the traffic information and a Shim header to the multiplex signal output from the multiplexing unit 270a. FIG. 22 is a flowchart illustrating an example of a transmission process of the control signal of yet another access device 2b. When the access device 2b is started, the CPU 20b receives a notification of initial values of the used bandwidth and the free bandwidth of each of the mobility traffic and the fixed traffic from the bandwidth monitoring unit 25b (operation St31a). Next, the CPU 20b generates the bandwidth table 230a from the used bandwidth and the free bandwidth of each of the mobility traffic and the fixed traffic (operation St32a).

Next, the CPU 20b determines whether a new notification has been received from the bandwidth monitoring unit 25b (operation St33a). When it is determined that the new notification has not been received (“No” in operation St33a), the process of operation St33a is executed again. When it is determined that the new notification has been received (“Yes” in operation St33a), the CPU 20b determines whether the used bandwidth and the free bandwidth of the mobility traffic have changed from the initial values (operation St34a). When it is determined that there is no change (“No” in operation St34a), the process of operation St33a is executed again.

When it is determined that there is a change (“Yes” in operation St34a), the CPU 20b updates the bandwidth table 230a according to the new notification (operation St35a). Next, the CPU 20b instructs the control signal generating unit 29b to generate a control signal (operation St36a). As a result, the information extracting unit 417 of the transmission device 1 acquires the traffic information and the Shim header from the control signal transmitted by the access device 2b. The Shim header is an example of fixed bandwidth information indicating the bandwidth of the fixed traffic.

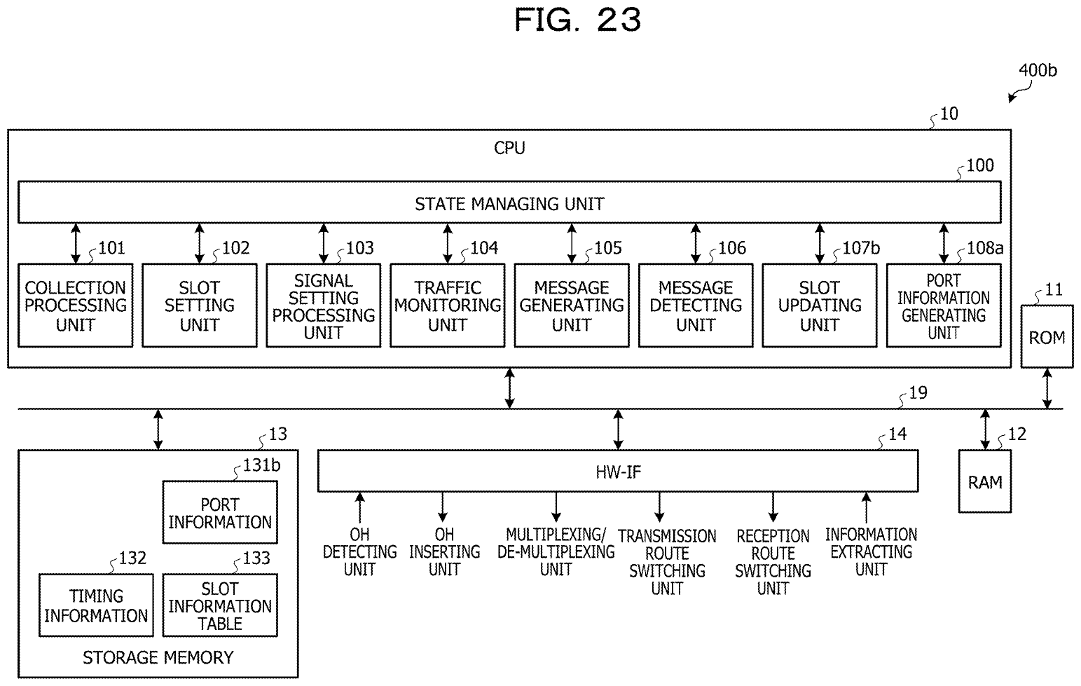

FIG. 23 is a configuration diagram illustrating an example of yet another control unit 400b. In FIG. 23, the configurations common to FIG. 14 are denoted by the same symbols, and the explanation thereof will not be repeated. The control unit 400b is provided in the transmission device 1, instead of the control unit 400, and corresponds to the transmission control unit CNT.

When reading a program from the ROM 11, the CPU 10 forms, its functions, a state managing unit 100, a collection processing unit 101, a slot setting unit 102, a signal setting processing unit 103, a traffic monitoring unit 104, a message generating unit 105, a message detecting unit 106, a slot updating unit 107b, and a port information generating unit 108a, The state managing unit 100, the collection processing unit 101, the slot setting unit 102, the signal setting processing unit 103, the traffic monitoring unit 104, the message generating unit 105, the message detecting unit 106, the slot updating unit 107b, and the port information generating unit 108a may be configured by circuits such as a FPGA and the like.

The port information generating unit 108a generates port information 131b from the information of the Shim header and stores the port information 131b in the storage memory 13. The port information 131b is different from the above-mentioned port information 131 in that the bandwidth for each port includes a used bandwidth for fixed traffic. That is, the port information generating unit 108a sets the total of used bandwidths of the mobility traffic and the fixed traffic of the bandwidth table 230a as the bandwidth of the port information 131b.

Therefore, the port information 131b indicates allocation of bandwidths of the mobility traffic and the fixed traffic to the ports P1 to Pn in each of the nodes A to E. The collection processing unit 101 collects the port information 131b from the storage memory 13, and the message generating unit 105 assigns the port information 131b to the collection message. As a result, the slots of the frame signals are allocated to the mobility traffic and the fixed traffic.

Further, the slot updating unit 107b updates the slot information table 133 based on the slot information assigned to the instruction message or the response message detected by the message detecting unit 106. The slot information assigned to the instruction message and the response message indicates the slots allocated to the mobility traffic and the fixed traffic. When the traffic increases or decreases, the slot updating unit 107b updates the slot information so that the slots allocated to the fixed traffic are maintained and the number of slots allocated to the mobility traffic increases or decreases.

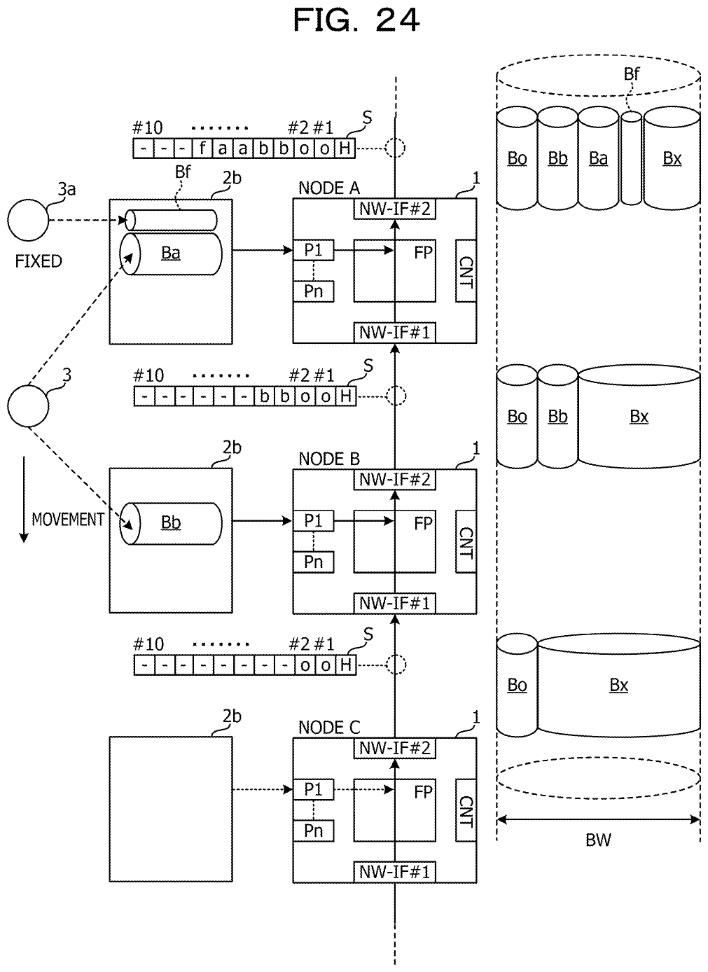

FIG. 24 is a diagram illustrating the bandwidth BW of the ring network NW before the movement of the terminal 3 when slots are allocated to fixed traffic. In FIG. 24, the configurations common to FIG. 7 are denoted by the same symbols, and the explanation thereof will not be repeated.

The access device 2 connected to the transmission device 1 of the node A receives fixed traffic from another terminal 3a via an access line. The accommodation destination node of the fixed traffic is fixed to the node A as an example. Here, the bandwidth of the fixed traffic bandwidth is defined as Bf. The access device 2 transmits the mobility traffic of the terminal 3 and the fixed traffic of another terminal 3a to the transmission device 1 of the node A.

In the transmission device 1 of the node A, the port P1 receives the mobility traffic of the terminal 3 and the fixed traffic of another terminal 3a. The transmission control unit CNT allocates the slots #5 and #6 to the Ethernet signal “b” of the mobility traffic and allocates the slot #7 to the Ethernet signal “f” of the fixed traffic.

Based on the slot information, the frame processing unit FP accommodates the Ethernet signal “a” in the slots #5 and #6 of the frame signal S received from the node B and accommodates the Ethernet signal “f” in the slot #7. The network interface unit NW-IF #2 transmits the frame signal S to the transmission device 4 of the adjacent node X.

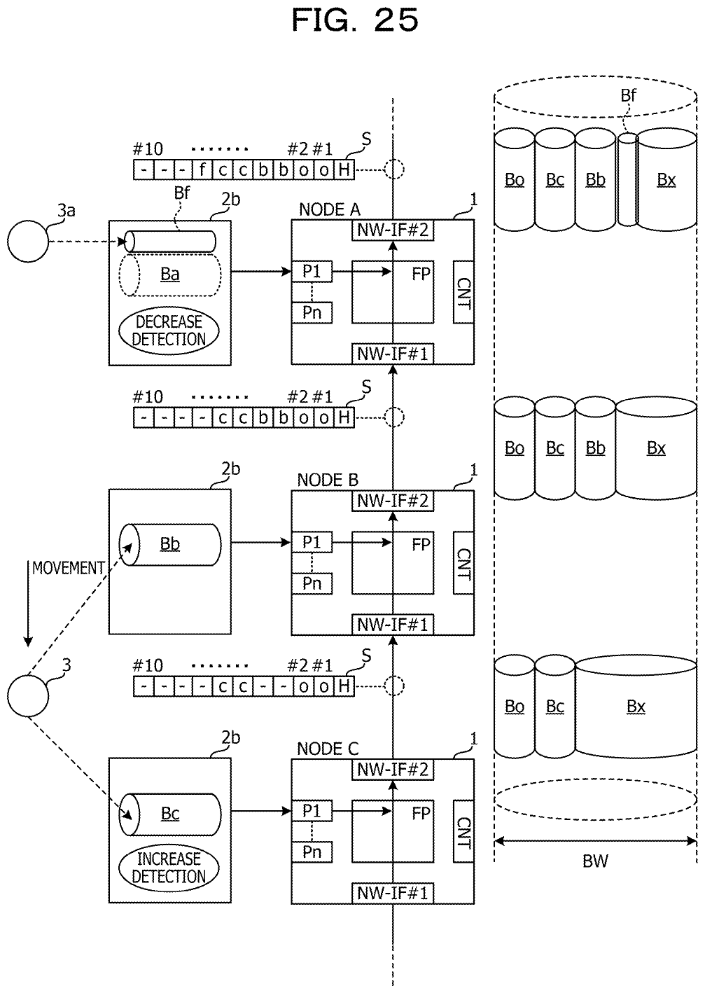

FIG. 25 is a diagram illustrating the bandwidth BW of the ring network NW after the movement of the terminal 3 when slots are allocated to fixed traffic. In FIG. 25, the configurations common to FIG. 8 are denoted by the same symbols, and the explanation thereof will not be repeated.

In the transmission device 1 of the node A, the port P1 receives only the fixed traffic of another terminal 3a due to the movement of the terminal 3. When receiving the instruction message from the transmission device 1 of the node C, the transmission control unit CNT updates the slot information so that the allocation of the slots #5 and #6 to the Ethernet signal “b” of the mobility traffic is deleted and the allocation of the slot #7 to the Ethernet signal “f” of the fixed traffic is maintained.

The frame processing unit FP accommodates the Ethernet signal “f” in the slot #7 based on the slot information. The network interface unit NW-IF #2 transmits the frame signal S to the transmission device 4 of the adjacent node X.

In this way, the control unit 400 maintains the allocation of one or more slots for the fixed traffic when the mobility traffic decreases. Therefore, the transmission device 1 may continue to accommodate the fixed traffic of another terminal 3a in the slots of the frame signal in the ring network NW regardless of the movement of the terminal 3.

### [Example of Other Traffic Information]

The bandwidth monitoring units 25, 25a, and 25b detect the increase or decrease in the traffic of the terminal 3 from the Ethernet signal received by the receiver 260, but the present disclosure is not limited thereto. As described below, it is also possible to detect the increase or decrease in the traffic of the terminal 3, for example, based on a BGP signaling signal relating to switching of the accommodation destination nodes A to E of the traffic of the terminal 3. The BGP signaling signal is defined in RFC 7432.

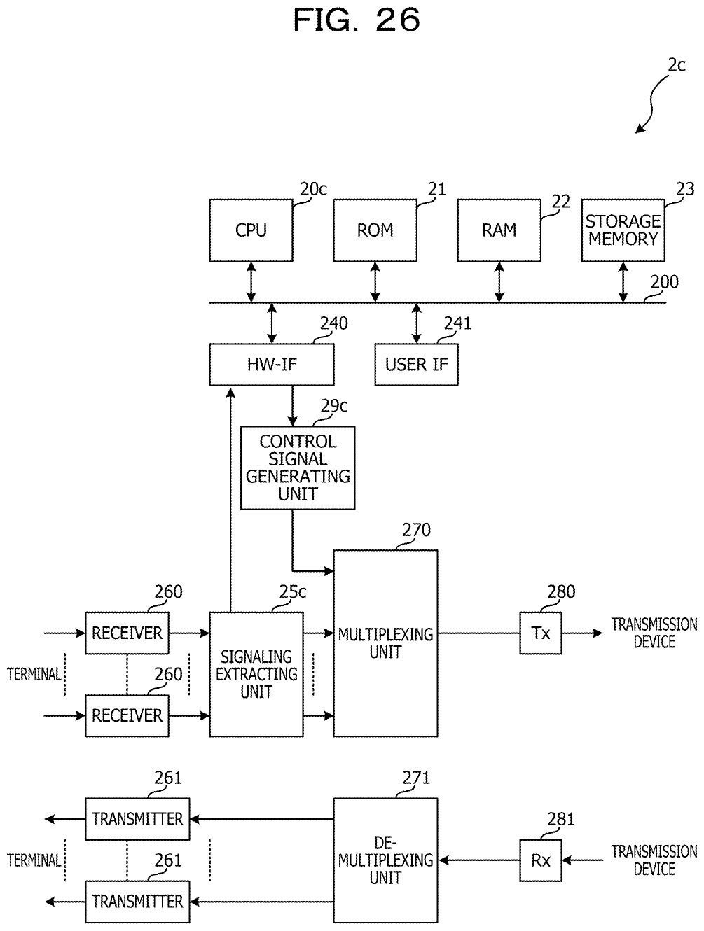

FIG. 26 is a configuration diagram illustrating an example of yet another access device 2c. In FIG. 26, the same symbols are given to the configurations common to those in FIG. 11, and the description thereof will be omitted.

The access device 2c generates traffic information from a BGP signaling signal. The access device 2c includes a CPU 20c, a ROM 21, a RAM 22, a storage memory 23, a HW-IF 240, and a user IF 241. The access device 2c further includes a plurality of receivers 260, a plurality of transmitters 261, a signaling extracting unit 25c, a control signal generating unit 29c, a multiplexing unit 270, a de-multiplexing unit 271, a transmitting port (Tx) 280, and a receiving port (Rx) 281.

The signaling extracting unit 25c extracts the BGP signaling signal from an Ethernet signal input from each receiver 260. The signaling extracting unit 25c extracts the BGP signaling signal based on, for example, the data format in the payload of the Ethernet signal. The signaling extracting unit 25c outputs the BGP signaling signal to the CPU 20c.

The BGP signaling signal is an example of a control signal related to switching of the accommodation destination nodes A to E of the traffic of the terminal 3. Based on the BGP signaling signal, the CPU 20c determines whether to set or delete a path of traffic of the terminal 3 to an access line. The traffic of the terminal 3 increases when the path is set, and the traffic of the terminal 3 decreases when the path is deleted. The CPU 20c instructs the control signal generating unit 29c to generate and transmit a control signal indicating the increase or decrease in the traffic.

The control signal generating unit 29c generates traffic information according to the instruction of the CPU 20c and transmits the generated traffic information from the multiplexing unit 270 to the transmission device 1. The control signal is transmitted to the transmission device 1 with it multiplexed with the Ethernet signal in the multiplexing unit 270.

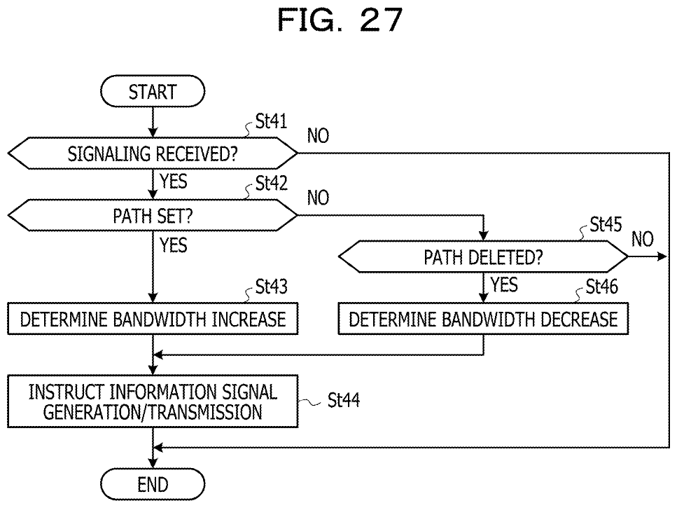

FIG. 27 is a flowchart illustrating an example of transmission process of a control signal of yet another access device 2c. The CPU 20c determines whether a BGP signaling signal has been received from the signaling extracting unit 25c (operation St41).

Next, the CPU 20c determines whether the BGP signaling signal instructs setting of the traffic path of the terminal 3 (operation St42). When the BGP signaling signal instructs the setting of the traffic path of the terminal 3 (“Yes” in the operation St42), the CPU 20c determines that the traffic of the terminal 3 increases (operation St43).

Further, when the BGP signaling signal does not instruct the setting of the traffic path of the terminal 3 (“No” in operation St42), the CPU 20c determines whether the BGP signaling signal instructs deletion of the traffic path of the terminal 3 (operation St45). When the BGP signaling signal instructs the deletion of the traffic path of the terminal 3 (“Yes” in operation St45), the CPU 20c determines that the traffic of the terminal 3 decreases (operation St46).

When the BGP signaling signal does not instruct the deletion of the traffic path of the terminal 3 (“No” in operation St45), the CPU 20c determines that there is no increase or decrease in the traffic of the terminal 3, and ends the process.

After the determination process of operations St43 and St46, the CPU 20c instructs the control signal generating unit 29c to generate and transmit traffic information indicating the increase or decrease in the traffic (operation St44). As a result, the control signal generating unit 29c transmits the traffic information to the transmission device 1, and the information extracting unit 417 of the transmission device 1 acquires the traffic information.

In this way, since the traffic information is based on the BGP signaling signal related to the switching of the accommodation destination nodes of the traffic, the transmission device 1 may acquire the traffic information more quickly than a case where the increase/decrease of bandwidth is directly detected as in other examples.

The above-described embodiment is an example of a suitable embodiment of the present disclosure. However, the present disclosure is not limited thereto, but various modifications may be made and carried out without departing from the gist of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device provided at a node of a plurality of nodes that forms a ring network, the transmission device comprising:
a port configured to receive traffic in which an accommodation destination node of the plurality of nodes switches between the nodes;
a first transmitter/receiver configured to transmit/receive a frame signal that includes a plurality of slots and an overhead to/from one node of adjacent nodes of the plurality of nodes;
a second transmitter/receiver configured to transmit/receive the frame signal to/from an other node of the adjacent nodes; and
a processor configured to:
arrange the traffic in one or more slots assigned, based on slot information, in the overhead among the slots of the frame signal received in one of the first transmitter/receiver and the second transmitter/receiver and to be transmitted from an other of the first transmitter/receiver and the second transmitter/receiver, the slot information indicating one or more slots allocated to the frame signal,
acquire traffic information that indicates an increase or decrease in the traffic,
update the slot information so that a number of slots in which the traffic is accommodated increases or decreases, based on the traffic information,
generate a message regarding update of the slot information based on the increase or decrease in the traffic, and
insert the message into the overhead of the frame signal received in the one of the first transmitter/receiver and the second transmitter/receiver and to be transmitted from the other of the first transmitter/receiver and the second transmitter/receiver.

2. The transmission device according to claim 1, wherein:
when the traffic information indicates the increase in the traffic,
the processor is configured to:
generate an instruction message that instructs a first node in which the traffic decreases, among the nodes, to update the slot information so that the number of slots decreases,
insert the instruction message into the overhead, and
when a response message in the overhead to the instruction message is received from the first node,
update the slot information so that the number of slots increases, and
when the traffic information indicates the decrease in the traffic, and when the instruction message for instructing of updating the slot information in the overhead is received from a second node in which the traffic increases, among the nodes,
the processor is configured to:
update the slot information so that the number of slots decreases,
generate a response message to the instruction message from the second node, and
insert the response message into the overhead.

3. The transmission device according to claim 1, wherein:
the processor is configured to acquire free bandwidth information that indicate a free bandwidth among bandwidths of a communication line that transmits the traffic,
the slot information indicates one or more slots allocated to the traffic and the free bandwidth, among the slots, and
the processor is configured to:
update the slot information so that one or more slots are allocated to the free bandwidth according to the increase in the traffic, and
update the slot information so that one or more slots allocated to the free bandwidth are deleted according to the decrease in the traffic.

4. The transmission device according to claim 1, wherein:
the port is further configured to receive another traffic in which the accommodation destination node is fixed to the node of the transmission device,
the processor is configured to acquire fixed bandwidth information that indicates a bandwidth of the another traffic,
the slot information indicates one or more slots to be allocated to the traffic and the another traffic, and
the processor is configured to:
arrange the traffic and the another traffic in one or more slots allocated, based on the slot information, among the slots of the frame signal received in one of the first transmitter/receiver and the second transmitter/receiver and transmitted from the other, and
maintain the allocation of one or more slots to the another traffic when the traffic decreases.

5. The transmission device according to claim 1, wherein the traffic information is based on a control signal related to switching of the accommodation destination node of the traffic.

6. A transmission method of a transmission device provided at a node of a plurality of nodes that forms a ring network, the transmission method comprising:
receiving traffic in which an accommodation destination node of the plurality of nodes switches between the nodes, by a port;
transmitting/receiving a frame signal that includes a plurality of slots and an overhead to/from one node of adjacent nodes of the plurality of nodes, by a first transmitter/receiver;
transmitting/receiving the frame signal to/from an other node of the adjacent nodes, by a second transmitter/receiver;
arranging the traffic in one or more slots assigned, based on slot information, in the overhead among the slots of the frame signal received in one of the first transmitter/receiver and the second transmitter/receiver and to be transmitted from an other of the first transmitter/receiver and the second transmitter/receiver, the slot information indicating one or more slots allocated to the frame signal, by a processor;
acquiring traffic information that indicates an increase or decrease in the traffic, by the processor;
updating the slot information so that a number of slots in which the traffic is accommodated increases or decreases, based on the traffic information, by the processor;
generate a message regarding update of the slot information based on the increase or decrease in the traffic, by the processor; and
inserting the message into the overhead of the frame signal received in the one of the first transmitter/receiver and the second transmitter/receiver and to be transmitted from the other of the first transmitter/receiver and the second transmitter/receiver, by the processor.

7. The transmission method according to claim 6, wherein:
when the traffic information indicates the increase in the traffic,
the processor is configured to:
generate an instruction message that instructs a first node in which the traffic decreases, among the nodes, to update the slot information so that the number of slots decreases,
insert the instruction message into the overhead, and
when a response message in the overhead to the instruction message is received from the first node,
update the slot information so that the number of slots increases, and
when the traffic information indicates the decrease in the traffic, and when the instruction message for instructing of updating the slot information in the overhead is received from a second node in which the traffic increases, among the nodes,
the processor is configured to:
update the slot information so that the number of slots decreases,
generate a response message to the instruction message from the second node, and
insert the response message into the overhead.

8. The transmission method according to claim 6, wherein:
the processor is configured to acquire free bandwidth information that indicate a free bandwidth among bandwidths of a communication line that transmits the traffic,
the slot information indicates one or more slots allocated to the traffic and the free bandwidth, among the slots, and
the processor is configured to:
update the slot information so that one or more slots are allocated to the free bandwidth according to the increase in the traffic, and
update the slot information so that one or more slots allocated to the free bandwidth are deleted according to the decrease in the traffic.

9. The transmission method according to claim 6, further comprising:
receiving another traffic in which the accommodation destination node is fixed to the node of the transmission device, by the port; and
acquiring fixed bandwidth information that indicates a bandwidth of the another traffic, by the processor,
wherein the slot information indicates one or more slots to be allocated to the traffic and the another traffic,
wherein the processor is configured to:
arrange the traffic and the another traffic in one or more slots allocated, based on the slot information, among the slots of the frame signal received in one of the first transmitter/receiver and the second transmitter/receiver and transmitted from the other, and
maintain the allocation of one or more slots to the another traffic when the traffic decreases.

10. The transmission method according to claim 6, wherein the traffic information is based on a control signal related to switching of the accommodation destination node of the traffic.
